(19) United States
(12) Patent Application Publication
(10) Pub. No.: US 2026/0308374 A1
(43) Pub. Date: Oct. 8, 2026

(54) POLYCARBONATE RESIN COMPOSITION AND MOLDED ARTICLE THEREOF

(71) Applicant: IDEMITSU KOSAN CO.,LTD., Tokyo (JP)

(72) Inventors: Yuki OGUSA, Chiyoda-ku, Tokyo (JP); Daisuke YOSHIZAWA, Chiyoda-ku, Tokyo (JP); Yasuhiro ISHIKAWA, Chiyoda-ku, Tokyo (JP)

(73) Assignee: IDEMITSU KOSAN CO.,LTD., Tokyo (JP)

(21) Appl. No.: 19/478,754

(22) PCT Filed: Apr. 25, 2024
(86) PCT No.: PCT/JP2024/016334

§ 371 Date: Oct. 24, 2025

(30) Foreign Application Priority Data
Apr. 28, 2023 (JP) 2023-075107

(51) Int. Cl. C08L 69/00; C08G 64/06; C08G 64/24

(52) U.S. Cl. CPC C08L 69/00; C08G 64/06; C08G 64/24; C08L 2201/10; C08L 2205/025

(57) ABSTRACT

The present invention relates to a polycarbonate-based resin composition including: an aromatic polycarbonate-based resin (A-1) including a structural unit represented by the following formula (II); and an aromatic polycarbonate-based resin (A-2) including a repeating unit represented by the following formula (I), wherein the ratio of the structural unit represented by the formula (II) to the total of the structural unit represented by the formula (II) and a repeating unit represented by the formula (III) is 50 mass % or more, and a molded article thereof.

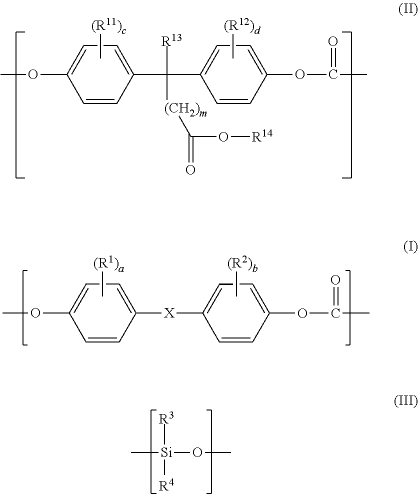

### TECHNICAL FIELD

The present invention relates to a polycarbonate-based resin composition and a molded article thereof.

### BACKGROUND ART

A polycarbonate-based resin is excellent in, for example, impact resistance, transparency, heat resistance, and self-extinguishing property, and hence has been widely utilized as an engineering plastic in various fields, such as an electrical and electronic equipment field, and an automotive field. However, the polycarbonate-based resin has low surface hardness, and is hence insufficient in scratch resistance in some cases.

In PTL 1, as a polycarbonate copolymer having improved scratch resistance, there is a disclosure of a polycarbonate copolymer including: a unit derived from a hydroxy-terminated monocyclic, polycyclic, or fused cyclic compound having a (meth)acrylate group; and a carbonate unit.

In PTL 2, there are disclosures of a fire-resistant polycarbonate resin, which is branched or crosslinked, and an intermediate thereof.

### CITATION LIST

### Patent Literature

PTL 1: KR 2016-0141268 A
PTL 2: JP H02-219818 A

### SUMMARY OF INVENTION

### Technical Problem

A method including coating the surface of the uppermost layer of a structural body formed of a polycarbonate-based resin has been known as a method of improving the surface hardness thereof. However, there is a problem in that a coating step is required, and hence a production process becomes complicated and an environmental load becomes larger.

Further, the invention described in PTL 1 is insufficient in surface hardness. In PTL 2, there is no description of a method of improving the surface hardness.

As described above, a further investigation has been required to achieve an improvement in scratch resistance with the polycarbonate-based resin alone.

An object of the present invention is to provide a polycarbonate-based resin composition and a molded article each improved in scratch resistance.

### Solution to Problem

The inventors of the present invention have found that the above-mentioned problems are solved by a polycarbonate-based resin composition including an aromatic polycarbonate-based resin including a specific structural unit.

That is, the present invention encompasses the following items 1 to 13.
1. A polycarbonate-based resin composition, including:
an aromatic polycarbonate-based resin (A-1) including a structural unit represented by the following formula (II); and
an aromatic polycarbonate-based resin (A-2) including a repeating unit represented by the following formula (I),
wherein a ratio of the structural unit represented by the formula (II) to a total of the structural unit represented by the formula (II) and a repeating unit represented by the formula (III) is 50 mass % or more:

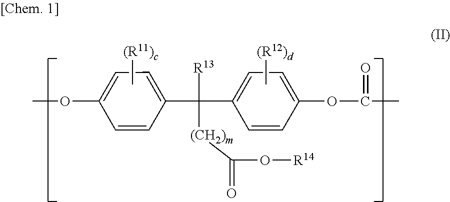

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a group selected from the group consisting of: a saturated or unsaturated cyclic hydrocarbon group having 3 to 20 carbon atoms; a substituted or unsubstituted alkyl group; and a 3- to 20-membered saturated or unsaturated heterocyclic group,
“c” and “d” each independently represent an integer of from 0 to 4, and
“m” represents an integer of from 0 to 20;

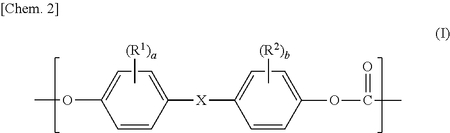

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4;

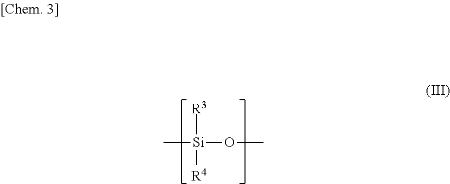

wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.
2. The polycarbonate-based resin composition according to Item 1, wherein R¹⁴ represents an alkyl group having 1 to 18 carbon atoms, a saturated or unsaturated cyclic hydrocarbon group having 3 to 12 carbon atoms, or a 3- to 12-membered saturated or unsaturated heterocyclic group.
3. The polycarbonate-based resin composition according to Item 2, wherein R¹⁴ represents a methyl group, a cyclopentyl group, or a cyclohexyl group.
4. The polycarbonate-based resin composition according to any one of Items 1 to 3, wherein “m” represents an integer of from 0 to 4.
5. The polycarbonate-based resin composition according to any one of Items 1 to 4, the aromatic polycarbonate-based resin (A-2) further includes a polyorganosiloxane block including the repeating unit represented by the formula (III).
6. The polycarbonate-based resin composition according to Item 5, wherein the repeating unit represented by the formula (III) is incorporated as a structural unit represented by any one of the following general formulae (III-I) to (III-III):

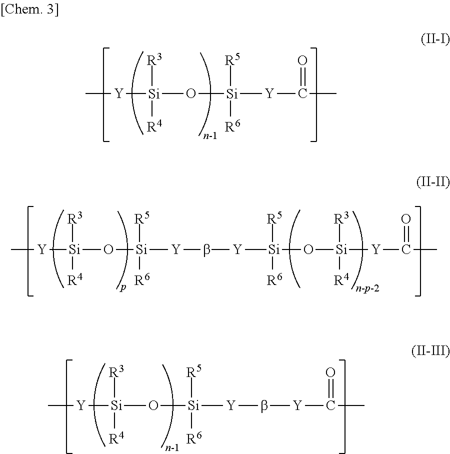

wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, p represents a divalent group derived from a diisocyanate compound, or a divalent group derived from a dicarboxylic acid or a dicarboxylic acid halide, “n” represents an integer of 31 or more and less than 91, and “p” represents an integer of 1 or more and n-2 or less.
7. The polycarbonate-based resin composition according to any one of Items 1 to 6, wherein of a content of the repeating unit represented by the formula (III) to a total content of the repeating unit represented by the formula (I), the repeating unit represented by the formula (II), and the repeating unit represented by the formula (III) is from 0.1 mass % to 3.2 mass %.
8. The polycarbonate-based resin composition according to any one of Items 1 to 7, wherein the aromatic polycarbonate-based resin (A-1) further includes the repeating unit represented by the formula (I).
9. The polycarbonate-based resin composition according to any one of Items 1 to 8, wherein a content of the structural unit represented by the formula (II) to a total content of the repeating unit represented by the formula (I), the repeating unit represented by the formula (II), and the repeating unit represented by the formula (III) is from 1.0 mass % to 25 mass %.
10. The polycarbonate-based resin composition according to any one of Items 1 to 9, wherein the aromatic polycarbonate-based resin (A-1) has a viscosity-average molecular weight (Mv) of from 10,000 to 100,000.
11. The polycarbonate-based resin composition according to any one of Items 1 to 10, wherein the aromatic polycarbonate-based resin (A-2) has a viscosity-average molecular weight (Mv) of from 15,000 to 25,000.
12. The polycarbonate-based resin composition according to any one of Items 1 to 11, wherein a molded article of the polycarbonate-based resin composition has a scratch hardness of HB or more, which is evaluated in conformity with JIS K5600-5-4.
13. A molded article of the polycarbonate-based resin composition of any one of Items 1 to 12.

### Advantageous Effects of Invention

The present invention can provide the polycarbonate-based resin composition and the molded article thereof each improved in scratch resistance.

### DESCRIPTION OF EMBODIMENTS

A polycarbonate-based resin composition and a molded article thereof of the present invention are described in detail below. In this description, a specification considered to be preferred may be arbitrarily adopted, and it can be said that a combination of preferred specifications is more preferred. The term “XX to YY” as used herein means “XX or more and YY or less.”

### 1. Polycarbonate-Based Resin Composition

The polycarbonate-based resin composition of the present invention includes: an aromatic polycarbonate-based resin (A-1) including a structural unit represented by the formula (II) to be described later; and an aromatic polycarbonate-based resin (A-2) including a repeating unit represented by the formula (I) to be described later. In addition, the ratio of the structural unit represented by the formula (II) to the total of the structural unit represented by the formula (II) and a repeating unit represented by the formula (III) to be described later is 50 mass % or more. The repeating unit represented by the formula (III) may be included in any one of the aromatic polycarbonate-based resin (A-1) and the aromatic polycarbonate-based resin (A-2), or may not be included therein.

In the polycarbonate-based resin composition of the present invention, the ratio of the structural unit represented by the formula (II) to the total of the structural unit represented by the formula (II) and the repeating unit represented by the formula (III) is 50 mass % or more, preferably 60 mass % or more, more preferably 70 mass % or more, still more preferably 80 mass % or more, and is preferably 100 mass % or less, more preferably 100 mass % from the viewpoint of improving the scratch resistance of the resin composition. In addition, when the polycarbonate-based resin composition includes the repeating unit represented by the formula (III), the ratio of the structural unit represented by the formula (II) to the total of the structural unit represented by the formula (II) and the repeating unit represented by the formula (III) is from 50 mass % to 100 mass %, preferably from 60 mass % to 100 mass %, more preferably from 70 mass % to 100 mass %, still more preferably from 80 mass % to 100 mass %. The term “total of the structural unit represented by the formula (II) and the repeating unit represented by the formula (III)” refers to the percentage of the mass of the structural unit represented by the formula (II) to the total mass of the mass of the structural unit represented by the formula (II) and the mass of the repeating unit represented by the formula (III) as required.

### [Aromatic Polycarbonate-Based Resin (A-1)]

The aromatic polycarbonate-based resin (A-1) includes the structural unit represented by the following formula (II).

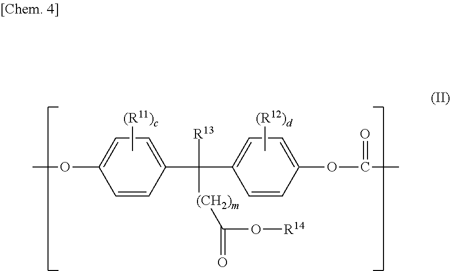

wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl (arylalkylene) group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a saturated or unsaturated cyclic hydrocarbon group having 3 to 20 carbon atoms, a substituted or unsubstituted alkyl group, or a 3- to 20-membered saturated or unsaturated heterocyclic group,
“c” and “d” each independently represent an integer of from 0 to 4, and
“m” represents an integer of from 0 to 20.

Examples of the halogen atom that R¹¹ and R¹² in the formula (II) each independently represent include a fluorine atom, a chlorine atom, a bromine atom, and an iodine atom.

Examples of the alkyl group having 1 to 18 carbon atoms that R¹¹ and R¹² each independently represent include a methyl group, an ethyl group, a n-propyl group, an isopropyl group, various butyl groups (the term “various” means that a linear group and all kinds of branched groups are included, and the same holds true for the following), various pentyl groups, and various hexyl groups.

Examples of the alkoxy group having 1 to 18 carbon atoms that R¹¹ and R¹² each independently represent include alkoxy groups whose alkyl group moieties are the above-mentioned alkyl groups.

Examples of the cycloalkyl group having 3 to 20 carbon atoms that R¹¹ and R¹² each independently represent include a cyclopropyl group, a cyclobutyl group, a cyclopentyl group, a cyclohexyl group, and a cycloheptyl group.

Examples of the cycloalkoxy group having 3 to 20 carbon atoms that R¹¹ and R¹² each independently represent include cycloalkoxy groups whose cycloalkyl group moieties are the above-mentioned cycloalkyl groups.

Examples of the alkenyl group having 2 to 10 carbon atoms that R¹¹ and R¹² each independently represent include an ethenyl group, a propenyl group, a butenyl group, a pentenyl group, and a hexenyl group.

Examples of the aryl group having 6 to 14 carbon atoms that R¹¹ and R¹² each independently represent include a phenyl group, a naphthyl group, a biphenyl group, and an anthryl group.

Examples of the aryloxy group having 6 to 14 carbon atoms that R¹¹ and R¹² each independently represent include aryloxy groups whose aryl group moieties are the above-mentioned aryl groups.

Examples of the aralkyl group having 7 to 20 carbon atoms that R¹¹ and R¹² each independently represent include a phenylmethyl group and a phenylethyl group.

Examples of the aralkyloxy group having 7 to 20 carbon atoms that R¹¹ and R¹² each independently represent include aralkyloxy groups whose aralkyl group moieties are the above-mentioned aralkyl groups.

Examples of the alkyl group having 1 to 5 carbon atoms represented by R¹³ in the formula (II) include a methyl group, an ethyl group, a n-propyl group, an isopropyl group, various butyl groups, and various pentyl groups.

Examples of the cycloalkyl group having 3 to 20 carbon atoms represented by R¹³ include a cyclopropyl group, a cyclobutyl group, a cyclopentyl group, a cyclohexyl group, and a cycloheptyl group.

Examples of the cycloalkoxy group having 3 to 20 carbon atoms represented by R¹³ include cycloalkoxy groups whose cycloalkyl group moieties are the above-mentioned cycloalkyl groups.

Examples of the alkenyl group having 2 to 10 carbon atoms represented by R¹³ include an ethenyl group, a propenyl group, a butenyl group, a pentenyl group, and a hexenyl group.

Examples of the aryl group having 6 to 14 carbon atoms represented by R¹³ include a phenyl group, a naphthyl group, a biphenyl group, and an anthryl group.

The saturated or unsaturated cyclic hydrocarbon group represented by R¹⁴ in the formula (II) has 3 to 20 carbon atoms, preferably 3 to 12 carbon atoms, more preferably 4 to 8 carbon atoms. Specific examples thereof include: cycloalkyl groups serving as saturated alicyclic groups, such as a cyclopropyl group, a cyclobutyl group, a cyclopentyl group, a cyclohexyl group, a cycloheptyl group, an adamantyl group, and a norbonyl group; cycloalkenyl groups serving as unsaturated alicyclic groups, such as a cyclopropenyl group, a cyclobutenyl group, a cyclopentenyl group, a cyclohexenyl group, and a cycloheptenyl group; and aryl groups, such as a phenyl group, a naphthyl group, a biphenyl group, and an anthryl group.

Examples of the substituted or unsubstituted alkyl group represented by R¹⁴ include: unsubstituted alkyl groups each having 1 to 18 carbon atoms, such as a methyl group, an ethyl group, a n-propyl group, an isopropyl group, various butyl groups, various pentyl groups, and various hexyl groups; and substituted alkyl groups such as a benzyl group.

The number of atoms for forming the ring of the heterocyclic group represented by R¹⁴ is from 3 to 20, and the ring has preferably 3 to 12 carbon atoms, more preferably 3 to 8 carbon atoms. The heterocyclic group is a cyclic group containing at least one heteroatom, for example, one, two, or three heteroatoms as ring-forming atoms. Specific examples of the heteroatom include a nitrogen atom, an oxygen atom, a sulfur atom, a silicon atom, a phosphorus atom, and a boron atom.

Examples of the heterocyclic group include a pyridinyl group, a pyrazinyl group, a pyrimidinyl group, a pyridazinyl group, a triazinyl group, an indolinyl group, a quinolinyl group, an acridinyl group, a pyrrolidinyl group, a dioxanyl group, a piperidinyl group, an oxiranyl group (epoxy group), an oxetanyl group, a morpholidinyl group, a piperazinyl group, a carbazolyl group, a furanyl group, a thiophenyl group, an oxazolyl group, an oxadiazolyl group, a benzoxazolyl group, a thiazolyl group, a thiadiazolyl group, a benzothiazolyl group, a triazolyl group, an imidazolyl group, a benzimidazolyl group, and a furanyl group.

R¹⁴ preferably represents an alkyl group having 1 to 18 carbon atoms, a saturated or unsaturated cyclic hydrocarbon group having 3 to 12 carbon atoms, or a 3- to 12-membered saturated or unsaturated heterocyclic group, more preferably represents an alkyl group having 1 to 3 carbon atoms, or a cycloalkyl group having 3 to 8 carbon atoms, and still more preferably represents a methyl group, a cyclopentyl group, or a cyclohexyl group.

“c” and “d” each independently represent an integer of from 0 to 4, preferably an integer of from 0 to 2, more preferably 0 or 1.

“m” represents an integer of from 0 to 20, preferably an integer of from 0 to 10, more preferably an integer of from 0 to 4, still more preferably 0, 1, 2, 3, or 4, still further more preferably 2.

In a preferred aspect of the formula (II), from the viewpoint of improving the scratch resistance of the resin composition, R¹⁴ represents a methyl group, a cyclopentyl group, or a cyclohexyl group, and “m” represents preferably from 0 to 2, more preferably 2. In addition, “c” and “d” each preferably represent O, and R¹³ represents preferably an alkyl group having 1 to 3 carbon atoms, more preferably a methyl group.

In the aromatic polycarbonate-based resin (A-1), the structural units each represented by the formula (II) may be used alone or in combination thereof.

The aromatic polycarbonate-based resin (A-1) may further include a repeating unit in addition to the structural unit represented by the formula (II). An example of such repeating unit is the repeating unit represented by the formula (I) in the following aromatic polycarbonate-based resin (A-2).

When the above-mentioned aromatic polycarbonate-based resin (A-1) includes the repeating unit represented by the formula (I), the aromatic polycarbonate-based resin is an aromatic polycarbonate-based copolymer including the repeating unit represented by the formula (I) and the structural unit represented by the formula (II).

When the aromatic polycarbonate-based resin (A-1) includes the repeating unit represented by the formula (I), the repeating unit represented by the formula (I) in the aromatic polycarbonate-based resin (A-1) and the repeating unit represented by the formula (I) in the aromatic polycarbonate-based resin (A-2) may be identical to or different from each other, but are preferably identical to each other from the viewpoint that the aromatic polycarbonate-based resin (A-1) and the aromatic polycarbonate-based resin (A-2) have high compatibility.

The aromatic polycarbonate-based resin (A-1) may include a constituent unit except the repeating unit represented by the formula (I) and the structural unit represented by the formula (II). Examples of such unit include a terminal structure derived from a terminal stopper to be described later and a silicon atom-containing constituent unit. An example of the silicon atom-containing constituent unit is the repeating unit represented by the formula (III) to be described later.

The content of the structural unit represented by the formula (II) in the aromatic polycarbonate-based resin (A-1) is preferably from 4 mass % to 35 mass %, more preferably from 6 mass % to 30 mass %, still more preferably from 8 mass % to 27 mass %, still further more preferably from 10 mass % to 25 mass %.

In the aromatic polycarbonate-based resin (A-1), the term “content of the structural unit represented by the formula (II)” refers to the percentage of the mass of the structural unit represented by the formula (II) to the total mass of the structural unit represented by the formula (II) and the repeating unit represented by the formula (I), and the repeating unit represented by the formula (III) as required. The same holds true for the “content of the repeating unit represented by the formula (I).”

The content of the structural unit represented by the formula (II) in the aromatic polycarbonate-based resin (A-1) is calculated by nuclear magnetic resonance (NMR) measurement. Specifically, ¹H-NMR measurement is performed, and the content is calculated from the integrated values of a peak derived from the structural unit represented by the formula (II), a peak derived from the structural unit represented by the formula (II), a peak derived from the repeating unit represented by the formula (I), and a peak derived from the repeating unit represented by the formula (III).

The viscosity-average molecular weight (Mv) of the aromatic polycarbonate-based resin (A-1) is preferably from 10,000 to 100,000, more preferably from 10,000 to 80,000, still more preferably from 15,000 to 30,000, still further more preferably from 17,000 to 25,000 in terms of its mechanical characteristics and moldability.

In the present invention, the viscosity-average molecular weight (Mv) is calculated from the following Schnell's equation after the determination of a limiting viscosity [η] through the measurement of the viscosity of a methylene chloride solution (concentration: g/L) at 20° C. with an Ubbelohde-type viscometer.

$$[ η ] = 1.23 \times 1 {0}^{- 5} {Mv}^{0.83}$$

### <Method of Producing Aromatic Polycarbonate-Based Resin (A-1)>

### (Dihydric Phenol-Based Compound)

The above-mentioned aromatic polycarbonate-based resin (A-1) may be suitably produced by using a dihydric phenol-based compound represented by the following formula (ii). The structural unit represented by the formula (II) of the above-mentioned aromatic polycarbonate-based resin is derived from the dihydric phenol-based compound represented by the formula (ii).

Accordingly, the present invention also provides a use of the dihydric phenol-based compound represented by the following formula (ii) for production of an aromatic polycarbonate-based resin:

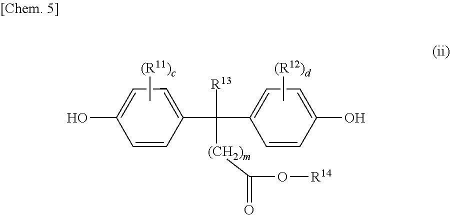

wherein in the formula (ii), R¹¹, R¹², R¹³, R¹⁴, “c”, “d”, and “m” are as defined above, and preferred examples thereof are also the same as those described above.

Preferred specific examples of the dihydric phenol-based compound represented by the formula (ii) include cyclohexyl diphenolate represented by the following formula (ii-1), cyclopentyl diphenolate represented by the following formula (ii-2), cyclohexyl 2,2-bis(4-hydroxyphenyl)propanoate represented by the following formula (ii-3), methyl diphenolate represented by the following formula (ii-4), and methyl 2,2-bis(4-hydroxy-3-methylphenyl)propanoate represented by the following formula (ii-5).

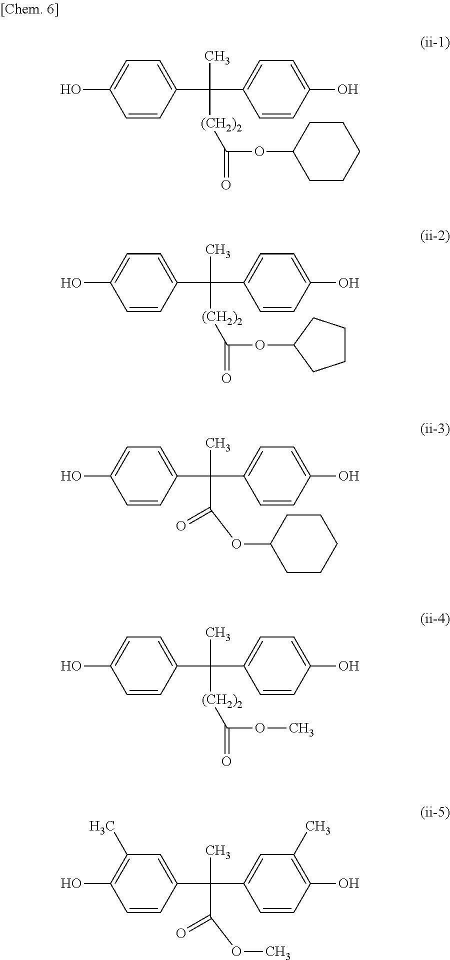

The dihydric phenol-based compound represented by the formula (ii) may be produced by, for example, causing a carboxylic acid compound (a-x) represented by the following formula (ii-x) and an alcohol compound (a-y) represented by the following formula (ii-y) to react with each other in the presence of an acid catalyst as required:

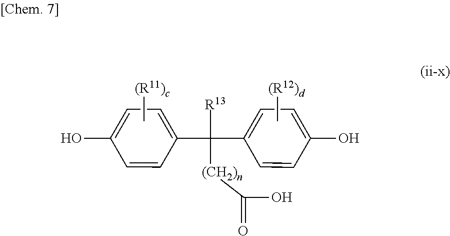

wherein in the formula (ii-x), R¹¹, R¹², R¹³, “c”, “d”, and “m” are as defined above, and preferred examples thereof are also the same as those described above;

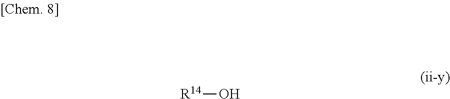

wherein in the formula (ii-y), R¹⁴ is as defined above, and preferred examples thereof are also the same as those described above.

### Method of Producing Aromatic Polycarbonate-Based Resin (A-1)

The above-mentioned aromatic polycarbonate-based resin (A-1) may be produced by a known method of producing a polycarbonate-based resin through use of the dihydric phenol-based compound represented by the formula (ii) as a dihydric phenol-based compound. Examples of the method of producing a polycarbonate-based resin include: (i) an interfacial polymerization method (phosgene method) including causing the dihydric phenol-based compound and phosgene to react with each other in the presence of an organic solvent inert to the reaction and an aqueous alkali solution, and then adding a polymerization catalyst, such as a tertiary amine or a quaternary ammonium salt, to polymerize the resultant; (ii) a melt polymerization method (ester exchange method) including subjecting the dihydric phenol-based compound and a carbonic acid diester to an ester exchange reaction under a molten state in which no solvent is used through the addition of a basic catalyst; and (iii) a pyridine method including dissolving the dihydric phenol-based compound in pyridine or a mixed solution containing pyridine and an inert solvent, and introducing phosgene into the solution to directly produce the resin.

A molecular weight modifier (terminal stopper), a branching agent, or the like is used as required in the above-mentioned reaction.

Among them, the following production method is preferred:
a method of producing an aromatic polycarbonate-based resin, including a step of subjecting the dihydric phenol-based compound and a polycarbonate oligomer to interfacial polycondensation in the presence of a water-insoluble organic solvent and an aqueous solution of an alkali compound, wherein the dihydric phenol-based compound includes the dihydric phenol-based compound represented by the formula (ii).

Specifically, in the case of the interfacial polymerization method, the above-mentioned aromatic polycarbonate-based resin may be produced by: dissolving a polycarbonate oligomer produced in advance to be described later in a water-insoluble organic solvent (e.g., methylene chloride); adding a solution of a dihydric phenol-based compound in an aqueous solution of an alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol such as p-tert-butylphenol) as required. In addition, in the case of the above-mentioned interfacial polymerization method, the above-mentioned aromatic polycarbonate-based resin may be produced by copolymerizing a dihydric phenol and phosgene, a carbonic acid ester, or a chloroformate.

The polycarbonate oligomer may be produced by a reaction between a dihydric phenol-based compound and a carbonate precursor, such as phosgene or triphosgene, in an organic solvent, such as methylene chloride, chlorobenzene, or chloroform. When the polycarbonate oligomer is produced by using an ester exchange method, the oligomer may be produced by a reaction between the dihydric phenol-based compound and a carbonate precursor such as diphenyl carbonate.

The dihydric phenol preferably further includes a dihydric phenol-based compound represented by the formula (i) from which the repeating unit represented by the formula (I) is derived. The dihydric phenol-based compound represented by the formula (i) is described in detail in the following method of producing the aromatic polycarbonate-based resin (A-2).

In a preferred production method, only the dihydric phenol-based compound represented by the formula (i) may be used as a dihydric phenol-based compound for producing the above-mentioned polycarbonate oligomer. In this case, in the step of the interfacial polycondensation reaction, the dihydric phenol-based compound represented by the formula (ii) and the dihydric phenol-based compound represented by the formula (i) are used in combination, or only the dihydric phenol-based compound represented by the formula (ii) is used.

When the aromatic polycarbonate-based resin (A-1) includes the repeating unit represented by the formula (III), the aromatic polycarbonate-based resin (A-1) may be produced by the same method as a method described in the following method of producing the aromatic polycarbonate-based resin (A-2), and compounds represented by the general formulae (iii-i) to (iii-iii) to be described in the method of producing the aromatic polycarbonate-based resin (A-2) may each be used as a polyorganosiloxane serving as a raw material in the same manner.

A terminal stopper (molecular weight modifier) may be used for adjusting the molecular weight of the aromatic polycarbonate-based resin to be obtained. Examples of the terminal stopper may include monohydric phenols, such as phenol, p-cresol, p-tert-butylphenol, p-tert-octylphenol, p-cumylphenol, p-nonylphenol, m-pentadecylphenol, and p-tert-amylphenol. Those monohydric phenols may be used alone or in combination thereof.

### Aromatic Polycarbonate-based Resin (A-2)

The aromatic polycarbonate-based resin (A-2) includes the repeating unit represented by the following formula (I). The aromatic polycarbonate-based resin (A-2) is free of the structural unit represented by the formula (II).

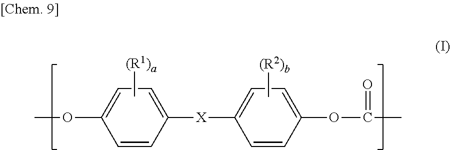

wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4.

Examples of the halogen atom that R¹ and R² in the formula (I) each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups, various pentyl groups, and various hexyl groups.

Examples of the alkoxy group that R¹ and R² each independently represent include alkoxy groups whose alkyl group moieties are the above-mentioned alkyl groups.

Examples of the cycloalkyl group that R¹ and R² each independently represent include a cyclopropyl group, a cyclobutyl group, a cyclopentyl group, a cyclohexyl group, and a cycloheptyl group.

Examples of the cycloalkyl group that R¹ and R² each independently represent include cycloalkoxy groups whose cycloalkyl group moieties are the above-mentioned cycloalkyl groups.

Examples of the alkenyl group that R¹ and R² each independently represent include an ethenyl group, a propenyl group, a butenyl group, a pentenyl group, and a hexenyl group.

Examples of the aryl group that R¹ and R² each independently represent include a phenyl group, a naphthyl group, a biphenyl group, and an anthryl group.

Examples of the aryloxy group that R¹ and R² each independently represent include aryloxy groups whose aryl group moieties are the above-mentioned aryl groups.

Examples of the aralkyl group that R¹ and R² each independently represent include a phenylmethyl group and a phenylethyl group.

Examples of the aralkyloxy group that R¹ and R² each independently represent include aralkyloxy groups whose aralkyl group moieties are the above-mentioned aralkyl groups.

The alkylene group represented by X has 1 to 8 carbon atoms, preferably 1 to 5 carbon atoms. Specific examples thereof include a methylene group, an ethylene group, a trimethylene group, a tetramethylene group, and a hexamethylene group.

Examples of the alkylidene group represented by X include an ethylidene group and an isopropylidene group.

The cycloalkylene group represented by X has 5 to 15 carbon atoms, preferably 5 to 10 carbon atoms. Specific examples thereof include a cyclopentanediyl group, a cyclohexanediyl group, and a cyclooctanediyl group.

Examples of the arylene group represented by X include a phenylene group, a naphthylene group, a biphenylene group, and a tetraphenyl group.

The cycloalkylidene group represented by X has 5 to 15 carbon atoms, preferably 5 to 10 carbon atoms. Specific examples thereof include a cyclohexylidene group, a 3,5,5-trimethylcyclohexylidene group, and a 2-adamantylidene group.

The aralkyl group represented by X has 7 to 20 carbon atoms, and examples of the aryl moiety thereof include aryl groups each having 6 to 14 ring-forming carbon atoms, such as a phenyl group, a naphthyl group, a biphenyl group, and an anthryl group.

A case in which X represents an isopropylidene group, a cyclohexylidene group, or a 3,5,5-trimethylcyclohexylidene group among those described above is preferred because the scratch resistance of a molded article of the polycarbonate-based resin composition can be improved.

“a” and “b” each independently represent an integer of from 0 to 4, preferably from 0 to 2, more preferably 0 or 1.

Among them, a case in which “a” and “b” each represent 0, and X represents a single bond or an alkylene group having 1 to 8 carbon atoms, or a case in which “a” and “b” each represent 0, and X represents an alkylidene group, in particular, an isopropylidene group is suitable.

In addition, as another aspect, a case in which “a” and “b” each represent 1, and X represents a single bond or an alkylene group having 1 to 8 carbon atoms, or a case in which “a” and “b” each represent 1, and X represents an alkylidene group, in particular, an isopropylidene group is also preferred because the scratch resistance of the molded article of the polycarbonate-based resin composition can be improved.

Specific examples of the repeating unit represented by the formula (I) include repeating units represented by the following general formulae (I-i) to (I-iv).

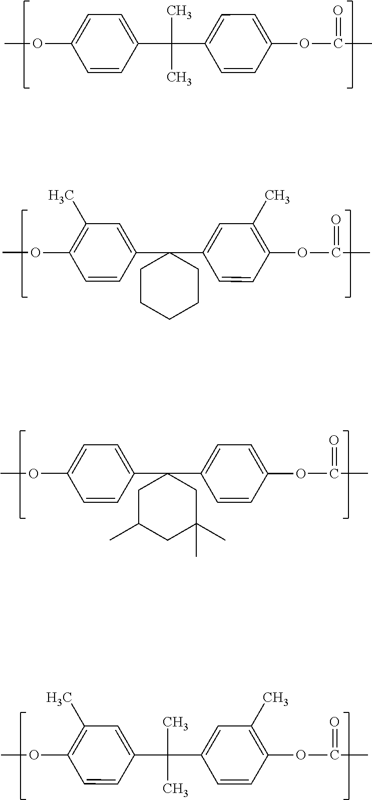

In the aromatic polycarbonate-based resin (A-2), the repeating units each represented by the formula (I) may be used alone or in combination thereof. Specifically, for example, the following aspects are given: an aspect in which the resin is formed only of the repeating unit represented by the general formula (I-i); and an aspect in which the resin is formed of a combination of the repeating unit represented by the general formula (I-i), and one or more kinds selected from the group consisting of the repeating units represented by the general formulae (I-ii) to (I-iv). Such aromatic polycarbonate-based resin (A-2) may be easily produced by an interfacial polymerization method in which a polycarbonate oligomer to be described later is produced in advance.

The aromatic polycarbonate-based resin (A-2) preferably further includes a polyorganosiloxane block including a repeating unit in addition to the repeating unit represented by the formula (I). An example of such repeating unit is the repeating unit represented by the following formula (III):

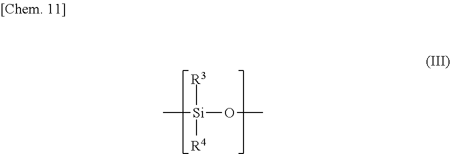

wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

Examples of the halogen atom that R³ and R⁴ in the formula (III) each independently represent include a fluorine atom, a chlorine atom, a bromine atom, and an iodine atom.

Examples of the alkyl group having 1 to 6 carbon atoms that R³ and R⁴ each independently represent include a methyl group, an ethyl group, a n-propyl group, an isopropyl group, various butyl groups, various pentyl groups, and various hexyl groups.

Examples of the alkoxy group having 1 to 6 carbon atoms that R³ and R⁴ each independently represent include alkoxy groups whose alkyl group moieties are the above-mentioned alkyl groups.

Examples of the aryl group having 6 to 12 carbon atoms that R³ and R⁴ each independently represent include a phenyl group and a naphthyl group.

R³ and R⁴ each preferably represent a hydrogen atom, an alkyl group having 1 to 6 carbon atoms, an alkoxy group having 1 to 6 carbon atoms, or an aryl group having 6 to 12 carbon atoms, and each more preferably represent a methyl group.

When the aromatic polycarbonate-based resin (A-2) includes the polyorganosiloxane block including the repeating unit represented by the formula (III), the average number of repetitions of the polyorganosiloxane block in the aromatic polycarbonate-based resin (A-2) is preferably from 20 to 100, more preferably from 25 to 95, still more preferably from 28 to 90, still further more preferably from 30 to 90. When the average number of repetitions falls within the above-mentioned ranges, the impact resistance of a polycarbonate-polyorganosiloxane copolymer can be improved.

The term “average number of repetitions of the polyorganosiloxane block” refers to the average of the numbers of —SiR³R⁴— groups per polyorganosiloxane block present between the two closest polycarbonate bonds on the main chain of the aromatic polycarbonate-based resin (A-2). In addition, the average number of repetitions of the repeating unit represented by the formula (III) in the polyorganosiloxane block is the average number of repetitions n-1 of the polyorganosiloxane block.

The average number of repetitions “n” of the repeating unit represented by the formula (III) in the aromatic polycarbonate-based resin (A-2) is calculated by nuclear magnetic resonance (NMR) measurement.

The repeating unit represented by the formula (III) in the aromatic polycarbonate-based resin (A-2) is preferably incorporated as a structural unit represented by any one of the following formulae (III-I) to (III-III) into the aromatic polycarbonate-based resin (A-2).

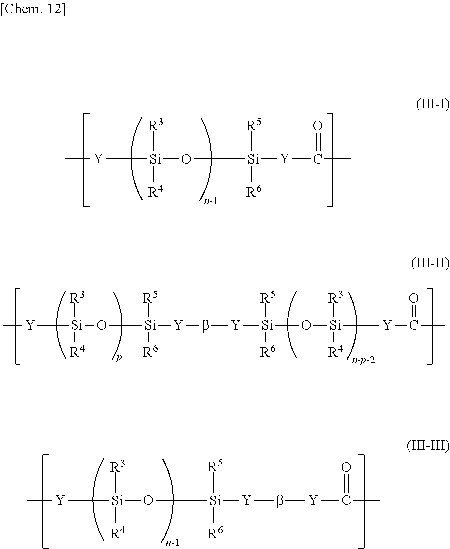

wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, β represents a divalent group derived from a diisocyanate compound, or a divalent group derived from a dicarboxylic acid or a dicarboxylic acid halide, “n” represents an integer of 31 or more and less than 91, and “p” represents an integer of 1 or more and n-2 or less.

Examples of the halogen atom that R³ to R⁶ each independently represent include a fluorine atom, a chlorine atom, a bromine atom, and an iodine atom.

Examples of the alkyl group having 1 to 6 carbon atoms that R³ to R⁶ each independently represent include a methyl group, an ethyl group, a n-propyl group, an isopropyl group, various butyl groups, various pentyl groups, and various hexyl groups.

Examples of the alkoxy group having 1 to 6 carbon atoms that R³ to R⁶ each independently represent include alkoxy groups whose alkyl group moieties are the above-mentioned alkyl groups.

Examples of the aryl group having 6 to 12 carbon atoms that R³ to R⁶ each independently represent include a phenyl group and a naphthyl group.

R³ to R⁶ each preferably represent a hydrogen atom, an alkyl group having 1 to 6 carbon atoms, an alkoxy group having 1 to 6 carbon atoms, or an aryl group having 6 to 12 carbon atoms.

R³ to R⁶ in the formula (III-I), the formula (III-II), and/or the formula (III-III) each preferably represent a methyl group.

In —R⁷O—, —R⁷COO—, —R⁷NH—, —R⁷NR⁸—, —R⁷COO—R⁹—O—, or —R⁷O—R¹⁰—O— represented by Y, R⁷ is bonded to a Si atom. In —COO— represented by Y, a C atom is bonded to the Si atom.

The linear or branched alkylene group represented by R⁷ in —R⁷O—, —R⁷COO—, —R⁷NH—, —R⁷NR⁸—, —R⁷COO—R⁹—O—, or —R⁷O—R¹⁰—O— represented by Y is, for example, an alkylene group having 1 to 8 carbon atoms, preferably 1 to 5 carbon atoms. The cyclic alkylene group represented by R⁷ is, for example, a cycloalkylene group having 5 to 15 carbon atoms, preferably 5 to 10 carbon atoms.

—R⁷¹R⁷²— represented by R⁷ may have a substituent, such as an alkoxy group or an alkyl group, on the arylene group represented by R⁷², and a specific structure thereof may be, for example, a structure represented by the following formula (1) or (2). Herein, when R⁷ represents —R⁷¹R⁷²—, the alkylene group represented by R⁷¹ is bonded to a Si atom.

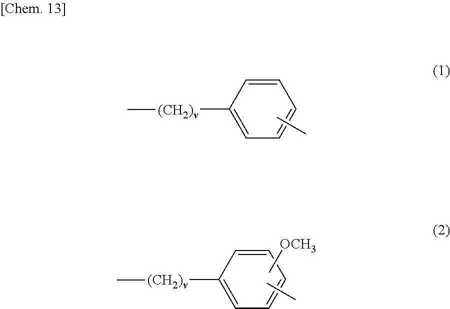

wherein in the formulae (1) and (2), “v” represents a positive integer, and typically represents an integer of from 1 to 6.

The diarylene group represented by each of R⁷, R⁹, and R¹⁰ is a group obtained by linking two arylene groups directly or through a divalent organic group, and is specifically a group having a structure represented by —Ar¹—W—Ar²—. Herein, Ar¹ and Ar² each represent an arylene group, and W represents a single bond or a divalent organic group. Examples of the divalent organic group represented by W include an isopropylidene group, a methylene group, a dimethylene group, and a trimethylene group.

Examples of the arylene group represented by each of R⁷, Ar¹, and Ar² include arylene groups each having 6 to 14 ring-forming carbon atoms, such as a phenylene group, a naphthylene group, a biphenylene group, and an anthrylene group. Those arylene groups may each have an optional substituent, such as an alkoxy group or an alkyl group.

The alkyl group represented by R⁸ is a linear or branched alkyl group having 1 to 8, preferably 1 to 5 carbon atoms. The alkenyl group represented by R⁸ is, for example, a linear or branched alkenyl group having 2 to 8, preferably 2 to 5 carbon atoms. The aryl group represented by R⁸ is, for example, a phenyl group or a naphthyl group. The aralkyl group represented by R⁸ is, for example, a phenylmethyl group or a phenylethyl group. The linear, branched, or cyclic alkylene group represented by R¹⁰ is the same as that of R⁷.

Y preferably represents —R⁷O— where R⁷ represents —R⁷¹R⁷²—. R⁷ represents more preferably a phenol-based compound residue having, in particular, an alkyl group, still more preferably an allylphenol-derived organic residue or a eugenol-derived organic residue among them.

With regard to “p” in the formula (III-II), p=n-p-2 is preferably satisfied.

β represents a divalent group derived from a diisocyanate compound, or a divalent group derived from a dicarboxylic acid or a dicarboxylic acid halide, and examples thereof include divalent groups represented by the following formulae (3) to (7).

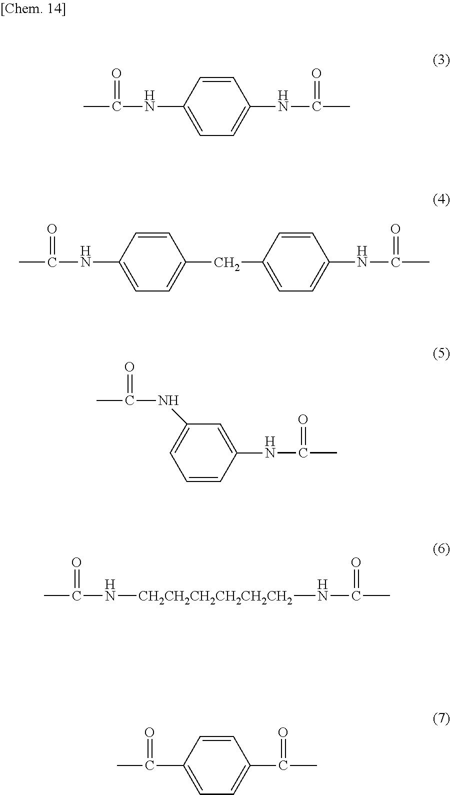

A block unit represented by the following formula (III-I) is, for example, a block unit represented by any one of the following formulae (III-I-1) to (III-I-11):

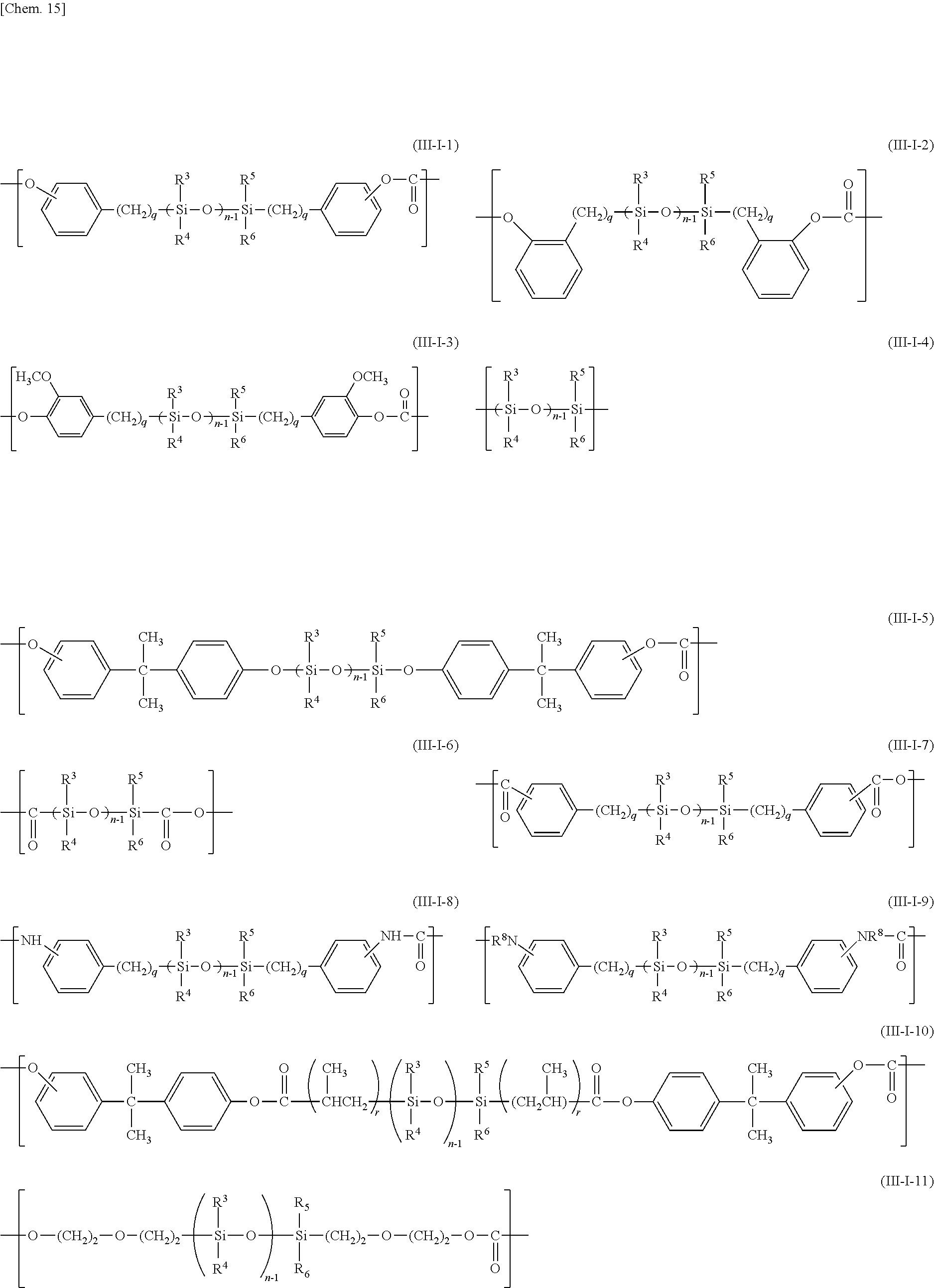

wherein in the formulae (III-I-1) to (III-I-11), R³ to R⁶, “n”, and R⁸ are the same as those described above, and preferred examples thereof are also the same as those described above, and “q” and “r” each independently represent a positive integer, and each typically represent an integer of from 1 to 6.

Among them, the block unit represented by the formula (III-I-1) is preferred from the viewpoint of the ease with which a polyorganosiloxane is polymerized. In addition, the block unit represented by the formula (III-I-2) or the block unit represented by the formula (III-I-3) is preferred from the viewpoint of ease of availability.

In addition, another preferred aspect of the polyorganosiloxane block is, for example, a block unit represented by the following formula (III-IV):

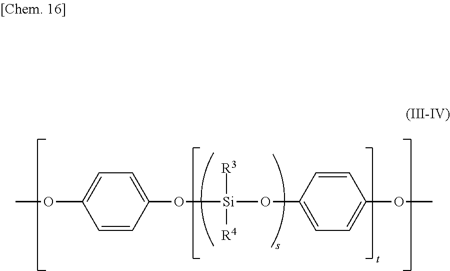

wherein in the formula (III-IV), R³ and R⁴ are the same as those described above, and s×t is equal to the above-mentioned “n”.

When the aromatic polycarbonate-based resin (A-2) includes the repeating unit represented by the formula (III), the content of the repeating unit represented by the formula (III) in the aromatic polycarbonate-based resin (A-2) is preferably from 0.5 mass % to 8 mass %, more preferably from 2 mass % to 7.5 mass %, still more preferably from 4 mass % to 7 mass %, particularly preferably from 5 mass % to 7 mass %.

In the aromatic polycarbonate-based resin (A-2), the term “content of the repeating unit represented by the formula (I)” refers to the percentage of the mass of the repeating unit represented by the formula (I) to the total mass of the repeating unit represented by the formula (I) and the repeating unit represented by the formula (III) as required. The same holds true for the “content of the repeating unit represented by the formula (III).”

The content of the repeating unit represented by the formula (I) in the aromatic polycarbonate-based resin (A-2) is calculated by nuclear magnetic resonance (NMR) measurement. Specifically, ¹H-NMR measurement is performed, and the content is calculated from the integrated values of a peak derived from the repeating unit represented by the formula (I) and a peak derived from the repeating unit represented by the formula (III).

The aromatic polycarbonate-based resin (A-2) may include a constituent unit except the repeating unit represented by the formula (I) and the repeating unit represented by the formula (III). Such unit is, for example, a terminal structure derived from a terminal stopper to be described later.

The viscosity-average molecular weight (Mv) of the aromatic polycarbonate-based resin (A-2) is preferably from 15,000 to 25,000, more preferably from 16,000 to 24,000, still more preferably from 16,500 to 23,000, particularly preferably from 17,000 to 22,000 in terms of its mechanical characteristics and moldability.

The viscosity-average molecular weight (Mv) of the aromatic polycarbonate-based resin (A-2) may be measured by the same method as that of the aromatic polycarbonate-based resin (A-1).

### Method of Producing Aromatic Polycarbonate-Based Resin (A-2)

The aromatic polycarbonate-based resin (A-2) may be produced by a known production method, such as the interfacial polymerization method (phosgene method), the pyridine method, or the ester exchange method described above. Particularly when the interfacial polymerization method is adopted, a step of separating an organic phase containing the aromatic polycarbonate-based resin (A-2), and an aqueous phase containing an unreacted product, a catalyst residue, and the like becomes easier, and hence the separation of the organic phase containing the aromatic polycarbonate-based resin (A-2) and the aqueous phase in each washing step based on, for example, alkali washing, acid washing, or pure water washing becomes easier. Accordingly, the aromatic polycarbonate-based resin (A-2) is efficiently obtained.

Specifically, the polycarbonate-based resin may be produced by: dissolving a polycarbonate oligomer produced in advance through use of a dihydric phenol-based compound represented by the following formula (i), and a polyorganosiloxane as required in a water-insoluble organic solvent (e.g., methylene chloride); adding a solution of a dihydric phenol-based compound (e.g., bisphenol A) in an aqueous solution of an alkali compound (e.g., aqueous sodium hydroxide) to the solution; and subjecting the mixture to an interfacial polycondensation reaction through use of a tertiary amine (e.g., triethylamine) or a quaternary ammonium salt (e.g., trimethylbenzylammonium chloride) as a polymerization catalyst in the presence of a terminal stopper (a monohydric phenol such asp-tert-butylphenol).

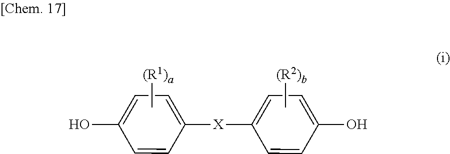

wherein in the formula (i), R¹, R², X, “a”, and “b” are as defined above, and preferred examples thereof are also the same as those described above.

Examples of the dihydric phenol-based compound represented by the formula (i) include: bis(hydroxyphenyl)alkane-based, such as 2,2-bis(4-hydroxyphenyl)propane [bisphenol A (BPA)], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl; bis(4-hydroxyphenyl)cycloalkanes; bis(4-hydroxyphenyl) oxide; bis(4-hydroxyphenyl) sulfide; bis(4-hydroxyphenyl) sulfone; bis(4-hydroxyphenyl) sulfoxide; and bis(4-hydroxyphenyl) ketone. Those dihydric phenol-based compounds may be used alone or as a mixture thereof.

Among them, bis(hydroxyphenyl)alkane-based dihydric phenols are preferred, and bisphenol A is more preferred.

When the aromatic polycarbonate-based resin (A-2) includes the repeating unit represented by the formula (III), as the method of producing the aromatic polycarbonate-based resin (A-2), reference may be made to, for example, a method described in JP 2014-80462 A.

A polyorganosiloxane represented by the following general formula (iii-i), (iii-ii), and/or (iii-iii) may be used as the polyorganosiloxane serving as a raw material:

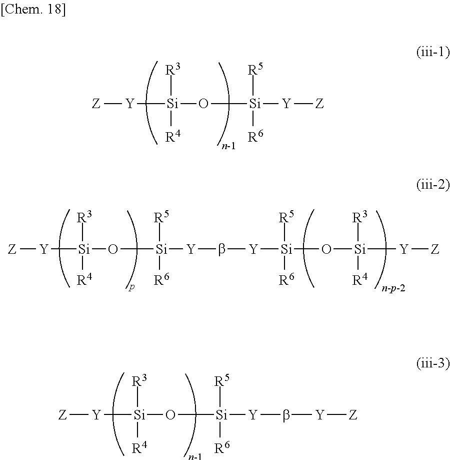

wherein R³ to R⁶, Y, 3, “n”, and “p” are as described above.

Specific examples of R³ to R⁶, Y, p, “n”, and “p”, and preferred examples thereof are also as described above.

Z represents a hydrogen atom or a halogen atom, and a plurality of Zs may be identical to or different from each other.

Examples of the polyorganosiloxane represented by the general formula (iii-i) include compounds represented by the following general formulae (iii-i-1) to (iii-i-11):

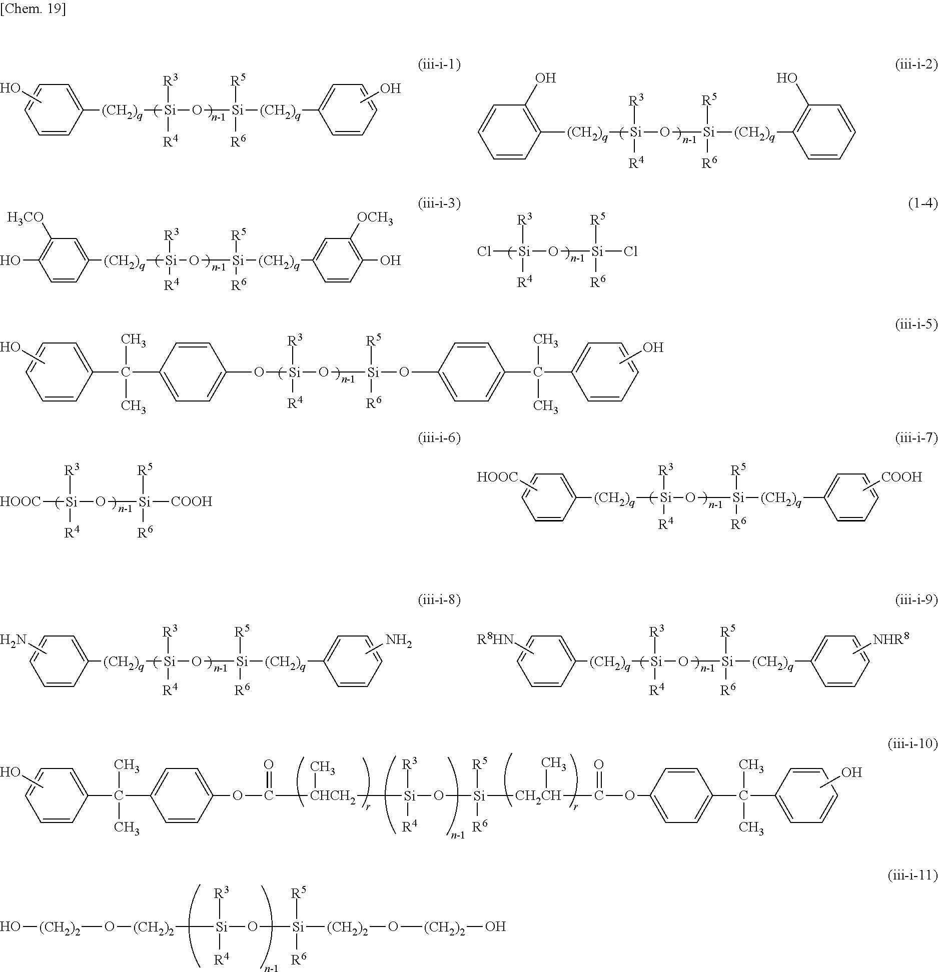

wherein in the general formulae (iii-i-1) to (iii-i-11), R³ to R⁶, n, and R⁸ are the same as those described above, and preferred examples thereof are also the same as those described above, and “q” and “r” each independently represent a positive integer, and each typically represent an integer of from 1 to 6.

Among them, a phenol-modified polyorganosiloxane represented by the general formula (iii-i-1) is preferred from the viewpoint of the ease with which the polyorganosiloxane is polymerized. In addition, an α,ω-bis[3-(o-hydroxyphenyl)propyl]polydimethylsiloxane, which is one kind of compound represented by the general formula (iii-i-2), or an α,ω-bis[3-(4-hydroxy-3-methoxyphenyl)propyl]polydimethylsiloxane, which is one kind of compound represented by the general formula (iii-i-3), is preferred from the viewpoint of ease of availability.

In addition to the foregoing, a compound represented by the following general formula (iii-iv) may be included as a polyorganosiloxane raw material:

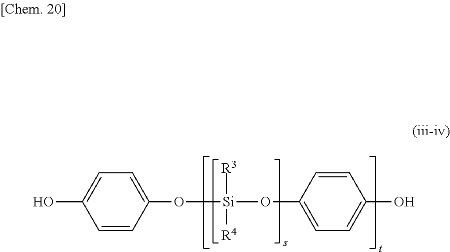

wherein R³, R⁴, “s”, and “t” are the same as those described above.

### [Polycarbonate-Based Resin Composition]

The polycarbonate-based resin composition of the present invention includes the above-mentioned aromatic polycarbonate resin (A-1) and aromatic polycarbonate resin (A-2), and as required, any other component.

Examples of the other component may include additives, such as a hydrolysis-resistant agent, an antioxidant, a UV absorber, a flame retardant, a flame retardant aid, a reinforcing material, a filler, an elastomer for an impact resistance improvement, a pigment, and a dye.

The polycarbonate-based resin composition may include an antioxidant from, for example, the viewpoint that its oxidative deterioration at the time of melting can be prevented, and hence its coloring or the like due to the oxidative deterioration is prevented.

The content of the antioxidant is preferably from 0.001 part by mass to 0.5 part by mass, more preferably from 0.01 part by mass to 0.3 part by mass, still more preferably from 0.02 part by mass to 0.2 part by mass with respect to 100 parts by mass of the content of the polycarbonate-based resin composition. When the content of the antioxidant falls within the above-mentioned ranges, a sufficient antioxidant action is obtained, and mold contamination at the time of the molding can be suppressed.

A method of producing the polycarbonate-based resin composition of the present invention is not particularly limited as long as the method includes a step of mixing the above-mentioned aromatic polycarbonate resin (A-1) and aromatic polycarbonate resin (A-2), and any other optional component. The polycarbonate-based resin composition may be produced by, for example, mixing the above-mentioned aromatic polycarbonate resin (A-1) and aromatic polycarbonate resin (A-2), and any other optional component with a mixer or the like, and melting and kneading the mixture. The melting and kneading may be performed by a typically used method such as a method including using, for example, a ribbon blender, a Henschel mixer, a Banbury mixer, a drum tumbler, a single-screw extruder, a twin-screw extruder, a co-kneader, or a multi-screw extruder. A heating temperature at the time of the melting and kneading is appropriately selected from the range of, for example, from 150° C. to 300° C., preferably from about 220° C. to about 300° C.

In the polycarbonate-based resin composition, a mass ratio ((A-1):(A-2)) between the aromatic polycarbonate resin (A-1) and the aromatic polycarbonate resin (A-2) is preferably from 45:55 to 95:5, more preferably from 50:50 to 90:10, still more preferably from 55:45 to 85:15, still further more preferably from 60:40 to 80:20.

The content of the structural unit represented by the formula (II) to the total content of the units represented by the formulae (I) to (III) in the polycarbonate-based resin composition is preferably from 1.0 mass % to 25 mass %, more preferably from 3.0 mass % to 23 mass %, still more preferably from 5.0 mass % to 21 mass %, still further more preferably from 6.0 mass % to 20 mass % from the viewpoint of improving the scratch resistance of the resin composition.

The polycarbonate-based resin composition preferably includes the repeating unit represented by the formula (III) from the viewpoint of improving the scratch resistance. The content of the repeating unit represented by the formula (III) to the total content of repeating units represented by the formulae (I) to (III) in the polycarbonate-based resin composition is preferably from 0.1 mass % to 3.2 mass %, more preferably from 0.5 mass % to 3.0 mass %, still more preferably from 0.8 mass % to 3.0 mass %, still further more preferably from 1.0 mass % to 2.5 mass %.

In the polycarbonate-based resin composition, the term “content of the structural unit represented by the formula (II)” refers to the percentage of the mass of the structural unit represented by the formula (II) to the total mass of the structural unit represented by the formula (II) and the repeating unit represented by the formula (I), and the repeating unit represented by the formula (III) as required. The same holds true for the “content of the repeating unit represented by the formula (III).”

The polycarbonate-based resin composition of the present invention can improve the scratch resistance of a molded article thereof.

The scratch resistance may be evaluated by scratch hardness (pencil method). The scratch hardness (pencil method) of the molded article of the above-mentioned polycarbonate-based resin composition evaluated in conformity with JIS K5600-5-4:1999 is preferably HB or more.

The polycarbonate-based resin composition of the present invention may be suitably used in a scratch-resistant application because a molded article thereof can be improved in excellent scratch resistance.

The scratch-resistant application is, for example, a structural body whose outer surface is formed of the above-mentioned polycarbonate-based resin composition, and more specific examples thereof include a resin window, a touch panel, an interior supply, an exterior supply, an interior part or an exterior part of a vehicle, a casing, an electric appliance, a building material, and OA equipment. The polycarbonate-based resin composition of the present invention may be suitably used for producing the above-mentioned articles.

### 2. Molded Article

The molded article of the present invention includes the above-mentioned polycarbonate-based resin composition. The molded article may be produced through use of a melt-kneaded product of the polycarbonate-based resin composition or a pellet thereof obtained through melting and kneading as a raw material by an injection molding method, an injection compression molding method, an extrusion molding method, a blow molding method, a press molding method, a vacuum molding method, an expansion molding method, or the like. In particular, the molded article is preferably produced through use of a pellet obtained through melting and kneading by an injection molding method or an injection compression molding method.

The thickness of the molded article may be arbitrarily set in accordance with applications, and particularly when the transparency of the molded article is required, the thickness is preferably from 0.2 mm to 4.0 mm, more preferably from 0.3 mm to 3.0 mm, still more preferably from 0.3 mm to 2.0 mm. When the thickness of the molded article is 0.2 mm or more, no warping occurs, and hence satisfactory mechanical strength is obtained. In addition, when the thickness of the molded article is 4.0 mm or less, high transparency is obtained.

The molded article formed of the polycarbonate-based resin composition of the present invention may be suitably used as, for example, a resin window, a touch panel, an interior supply, an exterior supply, an interior part or an exterior part of a vehicle, a casing, an electric appliance part, a building material, or an OA equipment part.

### EXAMPLES

Examples of the present invention are further described. The present invention is by no means limited by these examples. Measurement and evaluations in the respective examples were performed by the following methods.

### 1. Measurement of Viscosity-Average Molecular Weight (Mv)

A viscosity-average molecular weight (Mv) was calculated from the following equation (Schnell's equation) after the determination of a limiting viscosity [η] through the measurement of the viscosity of a methylene chloride solution (concentration: g/L) at 20° C. with an Ubbelohde-type viscometer.

[η]=1.23×10⁻⁵Mv^{0.83}

### 2. Conditions for ¹H-NMR Measurement

### Nuclear Magnetic Resonance (NMR) Apparatus:

“ECA-500” manufactured by JEOL RESONANCE Co., Ltd.
Probe: 50TH5AT/FG2
Measurement nucleus: ¹H
Observation width: from −5 ppm to 15 ppm
Observation center: 5 ppm
Pulse repetition time: 9 seconds
Pulse width: 45°
NMR sample tube: 5 mm #
Sample amount: from 30 mg to 40 mg
Solvent: deuterochloroform
Solvent amount: 0.4 mL
Measurement temperature: 25° C.
Number of scans: 256 times
Chemical shift correction: the peak of a methyl group derived from bisphenol A in a sample is set to a reference of 1.68 ppm.

### 3. Determination of Composition Ratio of Polycarbonate-Based Resin Composition

The ¹H-NMR measurement of a polycarbonate-based resin composition was performed under the same measurement conditions as those described above, and the structure of the polycarbonate-based resin composition was assigned.

### Synthesis Example 1 (Synthesis of Cyclohexyl Diphenolate)

620 Milliliters of cyclohexanol, 111 g (388 mmol) of diphenolic acid, and 5.69 g (58.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 800 mL of baking soda water (saturated aqueous solution of sodium hydrogen carbonate) twice and with 800 mL of brine (saturated salt solution) once. The organic phase was dried with anhydrous sodium sulfate, and was then concentrated under reduced pressure to provide 316 g of a pale brown liquid as a crude product. The resultant crude product was purified with a silica gel column (neutral silica gel: 1.05 kg, solvent: heptane/ethyl acetate=4/1) to provide 263 g of a pale yellow liquid. The resultant pale yellow liquid was subjected to azeotropy with a mixed solvent containing acetonitrile and water at 2:1 (300 g) eight times. The precipitated solid was recovered by filtration under reduced pressure, and was subjected to suspension washing with 500 mL of hexane twice. The resultant solid was dried under reduced pressure at 40° C. for 12 hours to provide 113 g of a white solid of cyclohexyl diphenolate.

### Synthesis Example 2 (Synthesis of Cyclopentyl Diphenolate)

694 Milliliters of cyclopentanol, 124 g (434 mmol) of diphenolic acid, and 6.37 g (65.0 mmol) of sulfuric acid were loaded into a 1-liter flask to provide a reaction liquid, and a stirrer chip, a temperature gauge, and a reflux tube were set therein. The temperature of the reaction liquid was increased to 80° C. with an oil bath, and the liquid was stirred with a magnetic stirrer for 19 hours. The disappearance of diphenolic acid was recognized by thin-layer chromatography (TLC), and then the temperature of the reaction liquid was returned to room temperature. 600 Milliliters of toluene was loaded into the reaction liquid, and the mixture was washed with 600 mL of baking soda water (saturated aqueous solution of sodium hydrogen carbonate) twice and with 600 mL of brine (saturated salt solution) once. The organic phase was dried with anhydrous sodium sulfate, and was then concentrated under reduced pressure to provide 172 g of a pale brown liquid as a crude product. The resultant crude product was dissolved in a mixture (350 g) containing hexane and ethyl acetate at 9:1, and the solution was left at room temperature overnight. The precipitated solid was recovered by filtration under reduced pressure, and was dried under reduced pressure at 40° C. for 12 hours to provide a white solid (55.3 g) of cyclopentyl diphenolate. The filtrate was left at rest at 4° C. overnight, and the precipitated solid was recovered by filtration under reduced pressure. The recovered solid was dried under reduced pressure at 40° C. for 12 hours to provide a white solid (38.5 g) of cyclopentyl diphenolate. The filtrate was concentrated under reduced pressure, and the resultant liquid was dissolved in chloroform (100 g). Toluene (180 g) was added to the solution, and the mixture was left at 4° C. overnight. The precipitated solid was recovered by filtration under reduced pressure, and was subjected to suspension washing with hexane twice. The washed solid was dried under reduced pressure at 50° C. for 12 hours to provide a white solid (14.4 g) of cyclopentyl diphenolate. A total of 108.2 g of cyclopentyl diphenolate was obtained.

### Synthesis Example 3 (Synthesis of Cyclohexyl 2,2-Bis(4-hydroxyphenyl)propanoate)

Phenol (131 g, 1.39 mol), pyruvic acid (60.3 g, 0.68 mol), and ion-exchanged water (45.6 g) were loaded into a 1-liter four-necked flask, and a stirrer chip and a temperature gauge were set therein. The flask was cooled with ice, and 95% sulfuric acid (112 g, 1.14 mol) was dropped thereinto over 50 minutes. After that, the temperature of the reaction liquid was increased to room temperature, and the liquid was stirred for 14 hours. Diethyl ether (1 L) was loaded into the reaction liquid, and the mixture was washed with ion-exchanged water (1 L) once. The organic layer was extracted with 0.1 M aqueous sodium hydroxide (1 L) twice. The pH of the extract was adjusted to 2 with 1 M hydrochloric acid, and the extract was extracted with diethyl ether (1 L) twice. The extract was dried with sodium sulfate, and was then dried under reduced pressure to provide a pale brown solid (139 g). The pale brown solid (130 g), cyclohexanol (2.01 L), and 95% sulfuric acid (27.7 g, 0.28 mol) were loaded into a 5-liter four-necked flask, and a stirring blade, a temperature gauge, and a reflux tube were set therein. After that, the temperature of the reaction liquid was increased to 100° C., and the liquid was stirred for 15 days. The reaction liquid was diluted twofold with diethyl ether, and was washed with baking soda water twice, with water once, and with brine once. The organic layer was dried with magnesium sulfate, and was concentrated under reduced pressure to provide a crude product (815 g). The crude product was purified with a silica gel column (neutral silica gel: 5.0 kg, solvent: chloroform/ethyl acetate=1/0→0/1) three times. After that, the purified product was dissolved in a solution containing chloroform and ethyl acetate at 1:1, and the solution was subjected to a recrystallization operation to provide a white solid (52.9 g) of cyclohexyl 2,2-bis(4-hydroxyphenyl)propanoate.

### Synthesis Example 4 (Synthesis of Methyl Diphenolate)

500 Milliliters of methanol, 50 g (175 mmol) of diphenolic acid, and 2.5 mL of sulfuric acid were loaded into a 1-liter flask, and a stirrer chip, a temperature gauge, and a reflux tube were set therein. The temperature of the reaction liquid was increased to 70° C. with an oil bath, and the liquid was stirred with a magnetic stirrer for 5 hours. The temperature of the reaction liquid was returned to room temperature, and then the liquid was concentrated under reduced pressure. Ethyl acetate was loaded into the reaction liquid, and the mixture was washed with 100 mL of baking soda water three times and with 100 mL of water twice. The solution was concentrated under reduced pressure to provide 55.3 g of a colorless solid as a crude product. The resultant crude product and 100 mL of toluene were loaded into a 200-milliliter flask, and a stirrer chip, a temperature gauge, and a reflux tube were set therein. The temperature of the reaction liquid was increased with the oil bath until toluene refluxed, followed by complete dissolution of the crude product in toluene. After that, the solution was left standing to cool to room temperature, and the precipitated solid was recovered by filtration under reduced pressure. The recovered solid was dissolved in 100 mL of toluene again, and the same operation was repeated. Thus, 32.7 g of a white solid of methyl diphenolate was obtained.

### Synthesis Example 5 (Synthesis of Methyl 2,2-Bis(4-hydroxy-3-methylphenyl)propanoate)

Methyl 2,2-bis(4-hydroxy-3-methylphenyl)propanoate was produced in the same manner as in Synthesis Example 3 except that phenol was changed to o-cresol.

### Synthesis Example 6 (Synthesis of Polycarbonate Oligomer 1)

Sodium dithionite (Na₂S₂O₄) was added to 5.6 mass % aqueous sodium hydroxide so that its concentration became 2,000 ppm with respect to bisphenol A (BPA) to be dissolved later. BPA was dissolved therein so that the concentration of BPA became 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 13 L/hr, and 4.5 kg/hr, respectively. The tubular reactor had a jacket portion and the temperature of the reaction liquid was kept at 40° C. or less by passing cooling water through the jacket. An aqueous phase was separated and removed by continuously taking the reaction liquid out of the tubular reactor and leaving the reaction liquid at rest. Then, a methylene chloride phase was collected.

The solution of the polycarbonate oligomer in methylene chloride thus obtained had a concentration of 301 g/L and a chloroformate group concentration of 1.03 mol/L.

### Synthesis Example 7 (Synthesis of Polycarbonate Oligomer 2)

Sodium dithionite was added to 5.6 mass % aqueous sodium hydroxide so that its concentration became 2,000 ppm with respect to bisphenol A (BPA) to be dissolved later. BPA was dissolved therein so that the concentration of BPA became 13.5 mass %. Thus, a solution of BPA in aqueous sodium hydroxide was prepared.

The solution of BPA in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively. The tubular reactor had a jacket portion and the temperature of the reaction liquid was kept at 40° C. or less by passing cooling water through the jacket. The reaction liquid that had exited the tubular reactor was continuously introduced into a baffled vessel-type reactor including a sweptback blade and having an internal value of 40 L. The solution of BPA in aqueous sodium hydroxide, 25 mass % aqueous sodium hydroxide, water, and a 1 mass % aqueous solution of triethylamine were further added at flow rates of 2.8 L/hr, 0.07 L/hr, 17 L/hr, and 0.64 L/hr, respectively to the reactor to perform a reaction. An aqueous phase was separated and removed by continuously taking out the reaction liquid overflowing the vessel-type reactor, and leaving the liquid at rest. Then, a methylene chloride phase was collected.

The polycarbonate oligomer thus obtained had a concentration of 341 g/L and a chloroformate group concentration of 0.71 mol/L.

### Production Example 1: Production of Aromatic Polycarbonate-Based Resin (A-1-1)

255 Milliliters of the solution of the polycarbonate oligomer 1 produced in Synthesis Example 6, 495 mL of methylene chloride, 21.2 g of cyclohexyl diphenolate produced in Synthesis Example 1 described above, and 178 L of triethylamine (TEA) were loaded into a 1-liter separable flask including a baffle board. Aqueous sodium hydroxide (obtained by dissolving 3.3 g of sodium hydroxide in 38.1 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 1.84 g of PTBP in 13 mL of methylene chloride) and a solution of BPA in aqueous sodium hydroxide (obtained by dissolving 17.9 g of BPA in an aqueous solution obtained by dissolving 9.9 g of sodium hydroxide and 36 mg of sodium dithionite in 145 mL of pure water) were added to the polymerization liquid, and the mixture was subjected to a polymerization reaction for 40 minutes.

100 Milliliters of methylene chloride was added for diluting the reaction liquid, and the mixture was stirred for 10 minutes. After that, the mixture was separated into an organic phase containing an aromatic polycarbonate-based resin (A-1-1), and an aqueous phase containing excess amounts of BPA and sodium hydroxide, and the organic phase was isolated. The solution of the aromatic polycarbonate-based resin (A-1-1) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-1) was obtained as a white product. The aromatic polycarbonate-based resin (A-1-1) had a content of the structural unit represented by the formula (II) of 21.3 mass % and a viscosity-average molecular weight (Mv) of 22,100.

### Production Example 2: Production of Aromatic Polycarbonate-Based Resin (A-1-2)

279 Milliliters of the solution of the polycarbonate oligomer 1 produced in Synthesis Example 6, 541 mL of methylene chloride, 10.5 g of cyclohexyl diphenolate produced in Synthesis Example 1 described above, and 195 L of triethylamine (TEA) were loaded into a 1-liter separable flask including a baffle board. Aqueous sodium hydroxide (obtained by dissolving 3.6 g of sodium hydroxide in 41.6 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 1.94 g of PTBP in 13 mL of methylene chloride) and a solution of BPA in aqueous sodium hydroxide (obtained by dissolving 21.7 g of BPA in an aqueous solution obtained by dissolving 10.9 g of sodium hydroxide and 43 mg of sodium dithionite in 159 mL of pure water) were added to the polymerization liquid, and the mixture was subjected to a polymerization reaction for 40 minutes.

30 Milliliters of methylene chloride was added for diluting the reaction liquid, and the mixture was stirred for 10 minutes. After that, the mixture was separated into an organic phase containing an aromatic polycarbonate-based resin (A-1-2), and an aqueous phase containing excess amounts of BPA and sodium hydroxide, and the organic phase was isolated. The solution of the aromatic polycarbonate-based resin (A-1-2) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-2) was obtained as a white product. The aromatic polycarbonate-based resin (A-1-2) had a content of the structural unit represented by the formula (II) of 10.6 mass % and a viscosity-average molecular weight (Mv) of 21,600.

### Production Example 3: Production of Aromatic Polycarbonate-Based Resin (A-1-3)

58 Milliliters of the solution of the polycarbonate oligomer 1 produced in Synthesis Example 6, 19 mL of methylene chloride, 4.15 g of cyclohexyl 2,2-bis(4-hydroxyphenyl)propanoate produced in Synthesis Example 3 described above, and 41 L of triethylamine (TEA) were loaded into a 300-milliliter separable flask including a baffle board. Aqueous sodium hydroxide (obtained by dissolving 0.9 g of sodium hydroxide in 9.8 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 0.34 g of PTBP in 2.4 mL of methylene chloride) and a solution of BPA in aqueous sodium hydroxide (obtained by dissolving 4.5 g of BPA in an aqueous solution obtained by dissolving 2.2 g of sodium hydroxide and 9 mg of sodium dithionite in 32 mL of pure water) were added to the polymerization liquid, and the mixture was subjected to a polymerization reaction for 40 minutes.

105 Milliliters of methylene chloride was added for diluting the reaction liquid, and the mixture was stirred for 10 minutes. After that, the mixture was separated into an organic phase containing an aromatic polycarbonate-based resin (A-1-3), and an aqueous phase containing excess amounts of BPA and sodium hydroxide, and the organic phase was isolated. The solution of the aromatic polycarbonate-based resin (A-1-3) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-3) was obtained as a white product. The aromatic polycarbonate-based resin (A-1-3) had a content of the structural unit represented by the formula (II) of 23.0 mass % and a viscosity-average molecular weight (Mv) of 22,300.

### Production Example 4: Production of Aromatic Polycarbonate-Based Resin (A-1-4)

283 Milliliters of the solution of the polycarbonate oligomer 1 produced in Synthesis Example 6, 94 mL of methylene chloride, 19.8 g of cyclopentyl diphenolate produced in Synthesis Example 2 described above, and 198 L of triethylamine (TEA) were loaded into a 1-liter separable flask including a baffle board. Aqueous sodium hydroxide (obtained by dissolving 3.7 g of sodium hydroxide in 42.2 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 1.56 g of PTBP in 11 mL of methylene chloride) and a solution of BPA in aqueous sodium hydroxide (obtained by dissolving 20.9 g of BPA in an aqueous solution obtained by dissolving 11 g of sodium hydroxide and 42 mg of sodium dithionite in 161 mL of pure water) were added to the polymerization liquid, and the mixture was subjected to a polymerization reaction for 40 minutes.

450 Milliliters of methylene chloride was added for diluting the reaction liquid, and the mixture was stirred for 10 minutes. After that, the mixture was separated into an organic phase containing an aromatic polycarbonate-based resin (A-1-4), and an aqueous phase containing excess amounts of BPA and sodium hydroxide, and the organic phase was isolated. The solution of the aromatic polycarbonate-based resin (A-1-4) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-4) was obtained as a white product. The aromatic polycarbonate-based resin (A-1-4) had a content of the structural unit represented by the formula (II) of 22.1 mass % and a viscosity-average molecular weight (Mv) of 25,400.

### Production Example 5: Production of Aromatic Polycarbonate-Based Resin (A-1-5)

58 Milliliters of the solution of the polycarbonate oligomer 1 produced in Synthesis Example 6, 19 mL of methylene chloride, 4.1 g of methyl 2,2-bis(4-hydroxy-3-methylphenyl)propanoate produced in Synthesis Example 5 described above, and 41 μL of triethylamine (TEA) were loaded into a 300-milliliter separable flask including a baffle board. Aqueous sodium hydroxide (obtained by dissolving 0.8 g of sodium hydroxide in 8.7 mL of pure water) was added to the flask under stirring, and the mixture was subjected to a reaction for 20 minutes to provide a polymerization liquid.

A solution of p-tert-butylphenol (PTBP) in methylene chloride (obtained by dissolving 0.34 g of PTBP in 2.4 mL of methylene chloride) and a solution of BPA in aqueous sodium hydroxide (obtained by dissolving 4.3 g of BPA in an aqueous solution obtained by dissolving 2.3 g of sodium hydroxide and 9 mg of sodium dithionite in 33 mL of pure water) were added to the polymerization liquid, and the mixture was subjected to a polymerization reaction for 40 minutes.

100 Milliliters of methylene chloride was added for diluting the reaction liquid, and the mixture was stirred for 10 minutes. After that, the mixture was separated into an organic phase containing an aromatic polycarbonate-based resin (A-1-5), and an aqueous phase containing excess amounts of BPA and sodium hydroxide, and the organic phase was isolated. The solution of the aromatic polycarbonate-based resin (A-1-5) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-5) was obtained as a white product. The aromatic polycarbonate-based resin (A-1-5) had a content of the structural unit represented by the formula (II) of 21.9 mass % and a viscosity-average molecular weight (Mv) of 22,200.

### Production Example 6: Production of Aromatic Polycarbonate-Based Resin (A-1-6)

50 Milliliters of the solution of the polycarbonate oligomer 1 produced in Synthesis Example 6, 70 mL of methylene chloride, 0.28 g of p-tert-butylphenol (PTBP), 3.4 g of methyl diphenolate produced in Synthesis Example 4 described above, and 35 μL of triethylamine (TEA) were loaded into a 300-milliliter separable flask including a baffle board. Aqueous sodium hydroxide (obtained by dissolving 0.6 g of sodium hydroxide in 7.5 mL of pure water) was added to the flask under stirring, and the mixture was subjected to a reaction for 20 minutes to provide a polymerization liquid.

A solution of BPA in aqueous sodium hydroxide (obtained by dissolving 3.7 g of BPA in an aqueous solution obtained by dissolving 1.6 g of sodium hydroxide and 7 mg of sodium dithionite in 24 mL of pure water) was added to the polymerization liquid, and the mixture was subjected to a polymerization reaction for 40 minutes.

50 Milliliters of methylene chloride was added for diluting the reaction liquid, and the mixture was stirred for 10 minutes. After that, the mixture was separated into an organic phase containing an aromatic polycarbonate-based resin (A-1-6), and an aqueous phase containing excess amounts of BPA and sodium hydroxide, and the organic phase was isolated. The solution of the aromatic polycarbonate-based resin (A-1-6) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less. The washed organic phase was turned into a flake by evaporating its solvent with an evaporator. Thus, the aromatic polycarbonate-based resin (A-1-6) was obtained as a white product. The aromatic polycarbonate-based resin (A-1-6) had a content of the structural unit represented by the formula (II) of 18.6 mass % and a viscosity-average molecular weight (Mv) of 10,100.

### Production Example 7: Production of Aromatic Polycarbonate-Based Resin (A-2-1)

15 Liters of the solution of the polycarbonate oligomer 2 produced in Synthesis Example 7, 8.6 L of methylene chloride, a solution, which was obtained by dissolving 400 g of an o-allylphenol terminal-modified polydimethylsiloxane in which the average chain length “n” of its polydimethylsiloxane was 37 in 2 L of methylene chloride, and 11.2 mL of TEA were loaded into a 50-liter vessel-type reactor including a baffle board, a paddle-type stirring blade, and a cooling jacket. Aqueous sodium hydroxide (obtained by dissolving 170 g of sodium hydroxide in 2 L of pure water) was added to the reactor under stirring, and a reaction between the polycarbonate oligomer and the allylphenol terminal-modified polydimethylsiloxane was performed for 20 minutes.

A solution of PTBP in methylene chloride (obtained by dissolving 112.5 g of PTBP in 0.5 L of methylene chloride) and a solution of BPA in aqueous sodium hydroxide (obtained by dissolving 826 g of BPA in an aqueous solution obtained by dissolving 562 g of sodium hydroxide and 1.7 g of sodium dithionite in 8.2 L of pure water) were added to the polymerization liquid, and the mixture was subjected to a polymerization reaction for 40 minutes.

8 Liters of methylene chloride was added for diluting the reaction liquid, and the mixture was stirred for 20 minutes. After that, the mixture was separated into an organic phase containing an aromatic polycarbonate-based resin (A-2-1), and an aqueous phase containing excess amounts of BPA and sodium hydroxide, and the organic phase was isolated.

The solution of the aromatic polycarbonate-based resin (A-2-1) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less.

The solution of the aromatic polycarbonate-based resin (A-2-1) in methylene chloride obtained by the washing was concentrated and pulverized, and the resultant flake was dried under reduced pressure at 120° C. to produce the aromatic polycarbonate-based resin (A-2-1). The aromatic polycarbonate-based resin (A-2-1) had a content of the repeating unit represented by the formula (I) of 94.0 mass %, a content of the repeating unit represented by the formula (III) of 6.0 mass %, an average number of repetitions of the repeating unit represented by the formula (III) of 38, and a viscosity-average molecular weight (Mv) of 21,300.

### Production Example 8: Production of Aromatic Polycarbonate-Based Resin (A-2-2)

15 Liters of the solution of the polycarbonate oligomer 2 produced in Synthesis Example 7, 10.1 L of methylene chloride, 407 g of an o-allylphenol terminal-modified polydimethylsiloxane in which the average chain length “n” of its polydimethylsiloxane was 88, and 8.4 mL of TEA were loaded into a 50-liter vessel-type reactor including a baffle board, a paddle-type stirring blade, and a cooling jacket. 1,065 Grams of aqueous sodium hydroxide obtained by dissolving 85 g of sodium hydroxide in 980 mL of pure water was added to the reactor under stirring, and a reaction between the polycarbonate oligomer and the allylphenol terminal-modified polydimethylsiloxane was performed for 20 minutes.

A solution of PTBP in methylene chloride (obtained by dissolving 147 g of PTBP in 1.0 L of methylene chloride) and a solution of BPA in aqueous sodium hydroxide (obtained by dissolving 1,093 g of BPA in an aqueous solution obtained by dissolving 618 g of sodium hydroxide and 2.1 g of sodium dithionite in 9.0 L of pure water) were added to the polymerization liquid, and the mixture was subjected to a polymerization reaction for 40 minutes.

13 Liters of methylene chloride was added for diluting the reaction liquid, and the mixture was stirred for 20 minutes. After that, the mixture was separated into an organic phase containing an aromatic polycarbonate-based resin (A-2-2), and an aqueous phase containing excess amounts of BPA and sodium hydroxide, and the organic phase was isolated.

The solution of the aromatic polycarbonate-based resin (A-2-2) in methylene chloride thus obtained was sequentially washed with 0.03 mol/L aqueous sodium hydroxide and 0.2 mol/L hydrochloric acid in amounts of 15 vol % each with respect to the solution. Next, the washed product was repeatedly washed with pure water until an electric conductivity in its aqueous phase after the washing became 5 S/cm or less.

The solution of the aromatic polycarbonate-based resin (A-2-2) in methylene chloride obtained by the washing was concentrated and pulverized, and the resultant flake was dried under reduced pressure at 120° C. to produce the aromatic polycarbonate-based resin (A-2-2). The aromatic polycarbonate-based resin (A-2-2) had a content of the repeating unit represented by the formula (I) of 94.0 mass %, a content of the repeating unit represented by the formula (III) of 6.0 mass %, an average number of repetitions of the repeating unit represented by the formula (III) of 88, and a viscosity-average molecular weight (Mv) of 17,700.

### Examples 1 to 9 and Comparative Examples 1 to 5

The aromatic polycarbonate-based resins (A-1-1) to (A-1-6), and (A-2-1) and (A-2-2) obtained in Production Examples 1 to 8, and TARFLON FN2200 (viscosity-average molecular weight (Mv): 21,700) manufactured by Idemitsu Kosan Co., Ltd. were mixed at blending ratios shown in Table 1, and were then dissolved in methylene chloride. The resultant methylene chloride solutions were concentrated and pulverized, and the resultant flakes were dried under reduced pressure at 120° C. to provide samples of polycarbonate-based resin compositions 1 to 9 and 11 to 15 for evaluation.

The samples for evaluation were each used to measure the contents of the repeating units represented by the formulae (I) to (III), the content of the structural unit represented by the formula (II) to the total of the structural unit represented by the formula (II) and the repeating unit represented by the formula (III), and the average number of repetitions of the repeating unit represented by the formula (III) in the polycarbonate-based resin composition. The results are shown in Table 1.

### (Evaluation of Scratch Hardness (Pencil Method))

The pellets of the polycarbonate-based resin compositions 1 to 9 and 11 to 15 for evaluation were each subjected to injection molding with an injection molding machine (“Mini Jet Pro” manufactured by Thermo Fisher Scientific, Inc.) under the conditions of a cylinder temperature of 290° C. and a mold temperature of 110° C. to produce a disc-shaped molded article (having a diameter of 30 mm and a thickness of 1.5 mm).

A line was drawn on the basis of JIS K 5600-5-4:1999 with a pencil under a state in which a load of 750 g was applied to the pencil while an angle of 45° was kept. The presence or absence of a scratch on the surface was visually inspected, and the scratch hardness (pencil method) was evaluated. A pencil hardness determined by the scratch hardness (pencil method) is a pencil hardness on any one of the following 14 stages: 6B to B, HB, F, and H to 6H.

The results are shown in Table 1.

TABLE 1

| | | | Example | Example | Example | Example | Example |
|---|---|---|---|---|---|---|---|
| | | | 1 | 2 | 3 | 4 | 5 |
| Polycarbonate-based resin composition | | | 1 | 2 | 3 | 4 | 5 |
| Composition | Aromatic polycarbonate- | A-1-1 | 80 | 60 | 60 | 60 | — |
| ratio*¹ | based resin (A-1) | A-1-2 | — | — | — | — | 80 |
| | | A-1-3 | — | — | — | — | — |
| | | A-1-4 | — | — | — | — | — |
| | | A-1-5 | — | — | — | — | — |
| | | A-1-6 | — | — | — | — | — |
| | Aromatic polycarbonate- | A-2-1 | 20 | 40 | — | — | 20 |
| | based resin (A-2) | A-2-2 | — | — | 40 | — | — |
| | | FN2200 | — | — | — | 40 | — |
| Content | Repeating unit represented by | | 81.2 | 84.5 | 84.3 | 87.0 | 90.2 |
| | formula (I) (mass %)*² | | | | | | |
| | Structural unit represented by | | 17.6 | 13.1 | 13.3 | 13.0 | 8.6 |
| | formula (II) (mass %)*² | | | | | | |
| | Repeating unit represented by | | 1.2 | 2.3 | 2.4 | 0.0 | 1.2 |
| | formula (III) (mass %)*² | | | | | | |
| | Structural unit represented by | | 93.5 | 84.9 | 84.4 | 100.0 | 87.5 |
| | formula (II) (mass %)*³ | | | | | | |
| Average number of repetitions of repeating | | | 34 | 36 | 82 | — | 40 |
| unit represented by formula (III) | | | | | | | |
| Evaluation | Scratch hardness | — | HB | HB | HB | F | HB |
| result | | | | | | | |

| | | | Example | Example | Example | Example |
|---|---|---|---|---|---|---|
| | | | 6 | 7 | 8 | 9 |
| Polycarbonate-based resin composition | | | 6 | 7 | 8 | 9 |
| Composition | Aromatic polycarbonate- | A-1-1 | — | — | — | — |
| ratio*¹ | based resin (A-1) | A-1-2 | — | — | — | — |
| | | A-1-3 | 80 | — | — | — |
| | | A-1-4 | — | 80 | — | — |
| | | A-1-5 | — | — | 80 | — |
| | | A-1-6 | — | — | — | 80 |
| | Aromatic polycarbonate- | A-2-1 | 20 | 20 | 20 | 20 |
| | based resin (A-2) | A-2-2 | — | — | — | — |
| | | FN2200 | — | — | — | — |
| Content | Repeating unit represented by | | 79.4 | 80.5 | 80.7 | 84.3 |
| | formula (I) (mass %)*² | | | | | |
| | Structural unit represented by | | 18.2 | 17.1 | 16.7 | 14.4 |
| | formula (II) (mass %)*² | | | | | |
| | Repeating unit represented by | | 1.2 | 1.2 | 1.3 | 1.3 |
| | formula (III) (mass %)*² | | | | | |
| | Structural unit represented by | | 93.8 | 93.4 | 92.7 | 91.7 |
| | formula (II) (mass %)*³ | | | | | |
| Average number of repetitions of repeating | | | 36 | 40 | 38 | 40 |
| unit represented by formula (III) | | | | | | |
| Evaluation | Scratch hardness | — | HB | HB | HB | HB |
| result | | | | | | |

| | | | Comparative | Comparative | Comparative | Comparative | Comparative |
|---|---|---|---|---|---|---|---|
| | | | Example 1 | Example 2 | Example 3 | Example 4 | Example 5 |
| Polycarbonate-based resin composition | | | 11 | 12 | 13 | 14 | 15 |
| Composition | Aromatic polycarbonate- | A-1-1 | — | — | — | — | 20 |
| ratio*¹ | based resin (A-1) | A-1-2 | — | — | — | — | — |
| | | A-1-3 | — | — | — | — | — |
| | | A-1-4 | — | — | — | — | — |
| | | A-1-5 | — | — | — | — | — |
| | | A-1-6 | — | — | — | — | — |
| | Aromatic polycarbonate- | A-2-1 | 100 | — | — | 40 | 80 |
| | based resin (A-2) | A-2-2 | — | — | 100 | — | — |
| | | FN2200 | — | 100 | — | 60 | — |
| Content | Repeating unit represented by | | 94.0 | 100 | 94.0 | 97.6 | 90.5 |
| | formula (I) (mass %)*² | | | | | | |
| | Structural unit represented by | | 0 | 0 | 0 | 0 | 4.6 |
| | formula (II) (mass %)*² | | | | | | |
| | Repeating unit represented by | | 6.0 | 0 | 6.0 | 2.4 | 4.9 |
| | formula (III) (mass %)*² | | | | | | |
| | Structural unit represented by | | 0 | 0 | 0 | 0 | 48.4 |
| | formula (II) (mass %)*³ | | | | | | |
| Average number of repetitions of repeating | | | 38 | — | 88 | 40 | 39 |
| unit represented by formula (III) | | | | | | | |
| Evaluation | Scratch hardness | — | B | B | B | B | B |
| result | | | | | | | |

*¹the ratio means part(s) by mass with respect to 100 parts by mass of the total of the polycarbonate-based resin compositions (A-1) and (A-2)
*²the content means a content (mass %) of each unit to the total of the units represented by the formulae (I) to (III) in the polycarbonate-based resin composition
*³the content means a content (mass %) of the structural unit represented by the formula (II) to the total of the structural unit represented by the formula (II) and the repeating unit represented by the formula (III) in the polycarbonate-based resin composition

As shown in Table 1, the polycarbonate-based resin compositions 1 to 9 of the present invention were each improved in scratch resistance.

Meanwhile, the polycarbonate-based resin compositions ii to 14, each of which was free of the aromatic polycarbonate-based resin (A-i) including the structural unit represented by the formula (II), and the polycarbonate-based resin composition 15, which included the structural unit represented by the formula (II), but did not sufficiently include the unit with respect to the total of the structural unit represented by the formula (II) and the repeating unit represented by the formula (III), were each poor in scratch resistance.

1. A polycarbonate-based resin composition, comprising:
an aromatic polycarbonate-based resin (A-1) comprising a structural unit represented by the following formula (II); and
an aromatic polycarbonate-based resin (A-2) comprising a repeating unit represented by the following formula (I),
wherein a ratio of the structural unit represented by the formula (II) to a total of the structural unit represented by the formula (II) and a repeating unit represented by the formula (III) is 50 mass % or more: 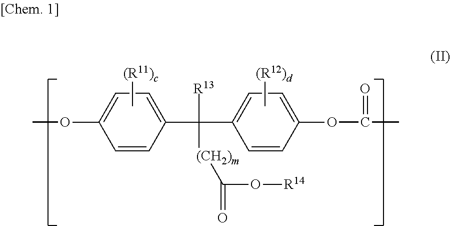
wherein in the formula (II),
R¹¹ and R¹² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
R¹³ represents a hydrogen atom, or a group selected from the group consisting of: an alkyl group having 1 to 5 carbon atoms; a cycloalkyl group having 3 to 20 carbon atoms; a cycloalkoxy group having 3 to 20 carbon atoms; an alkenyl group having 2 to 10 carbon atoms; and an aryl group having 6 to 14 carbon atoms,
R¹⁴ represents a group selected from the group consisting of: a saturated or unsaturated cyclic hydrocarbon group having 3 to 20 carbon atoms; a substituted or unsubstituted alkyl group; and a 3- to 20-membered saturated or unsaturated heterocyclic group,
“c” and “d” each independently represent an integer of from 0 to 4, and
“m” represents an integer of from 0 to 20; 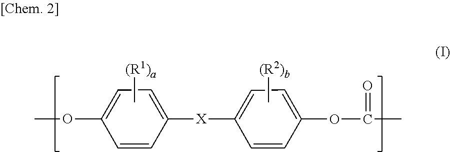
wherein in the formula (I),
R¹ and R² each independently represent a halogen atom, or a group selected from the group consisting of: an alkyl group having 1 to 18 carbon atoms; an alkoxy group having 1 to 18 carbon atoms; a cycloalkyl group having 3 to 20 carbon atoms; a cycloalkoxy group having 3 to 20 carbon atoms; an alkenyl group having 2 to 10 carbon atoms; an aryl group having 6 to 14 carbon atoms; an aryloxy group having 6 to 14 carbon atoms; an aralkyl group having 7 to 20 carbon atoms; an aralkyloxy group having 7 to 20 carbon atoms; a nitro group; an aldehyde group; a cyano group; and a carboxyl group,
X represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, an aralkyl group having 7 to 20 carbon atoms, —S—, —SO—, —SO₂—, —O—, or —CO—, and
“a” and “b” each independently represent an integer of from 0 to 4; 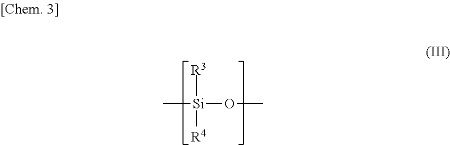
wherein in the formula (III), R³ and R⁴ each independently represent a hydrogen atom, a halogen atom, an alkyl group having 1 to 6 carbon atoms, an alkoxy group having 1 to 6 carbon atoms, or an aryl group having 6 to 12 carbon atoms.

2. The polycarbonate-based resin composition according to claim 1, wherein R¹⁴ represents an alkyl group having 1 to 18 carbon atoms, a saturated or unsaturated cyclic hydrocarbon group having 3 to 12 carbon atoms, or a 3- to 12-membered saturated or unsaturated heterocyclic group.

3. The polycarbonate-based resin composition according to claim 2, wherein R¹⁴ represents a methyl group, a cyclopentyl group, or a cyclohexyl group.

4. The polycarbonate-based resin composition according to claim 1, wherein “m” represents an integer of from 0 to 4.

5. The polycarbonate-based resin composition according to claim 1, wherein the aromatic polycarbonate-based resin (A-2) further comprises a polyorganosiloxane block comprising the repeating unit represented by the formula (III).

6. The polycarbonate-based resin composition according to claim 5, wherein the repeating unit represented by the formula (III) is incorporated as a structural unit represented by any one of the following general formulae (III-I) to (III-III): 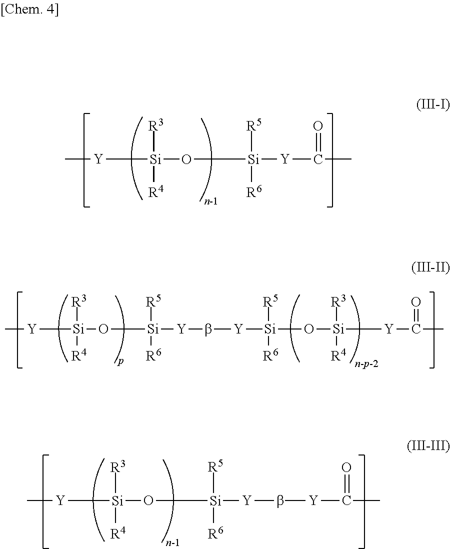
wherein in the formulae (III-I) to (III-III), R³ to R⁶ each independently represent a hydrogen atom, a halogen atom, an alkyl group having 1 to 6 carbon atoms, an alkoxy group having 1 to 6 carbon atoms, or an aryl group having 6 to 12 carbon atoms, and a plurality of R³s to R⁶s may be identical to or different from each other, Y represents —R⁷O—, —R⁷COO—, —R⁷NH—, —R⁷NR⁸—, —COO—, —S—, —R⁷COO—R⁹—O—, or —R⁷O—R¹⁰—O—, and a plurality of Ys may be identical to or different from each other, the R⁷ represents a single bond, a linear, branched, or cyclic alkylene group, —R⁷¹R⁷²—, a substituted or unsubstituted arylene group, or a diarylene group, R⁷¹ represents a linear, branched, or cyclic alkylene group, R⁷² represents a substituted or unsubstituted arylene group, R⁸ represents an alkyl group, an alkenyl group, an aryl group, or an aralkyl group, R⁹ represents a diarylene group, R¹⁰ represents a linear, branched, or cyclic alkylene group, or a diarylene group, p represents a divalent group derived from a diisocyanate compound, or a divalent group derived from a dicarboxylic acid or a dicarboxylic acid halide, “n” represents an integer of 31 or more and less than 91, and “p” represents an integer of 1 or more and n-2 or less.

7. The polycarbonate-based resin composition according to claim 1, wherein a content of the repeating unit represented by the formula (III) to a total content of the repeating unit represented by the formula (I), the repeating unit represented by the formula (II), and the repeating unit represented by the formula (III) is from 0.1 mass % to 3.2 mass %.

8. The polycarbonate-based resin composition according to claim 1, wherein the aromatic polycarbonate-based resin (A-1) further comprises the repeating unit represented by the formula (I).

9. The polycarbonate-based resin composition according to claim 1, wherein a content of the structural unit represented by the formula (II) to a total content of the repeating unit represented by the formula (I), the repeating unit represented by the formula (II), and the repeating unit represented by the formula (III) is from 1.0 mass % to 25 mass %.

10. The polycarbonate-based resin composition according to claim 1, wherein the aromatic polycarbonate-based resin (A-1) has a viscosity-average molecular weight (Mv) of from 10,000 to 100,000.

11. The polycarbonate-based resin composition according to claim 1, wherein the aromatic polycarbonate-based resin (A-2) has a viscosity-average molecular weight (Mv) of from 15,000 to 25,000.

12. The polycarbonate-based resin composition according to claim 1, wherein a molded article of the polycarbonate-based resin composition has a scratch hardness of HB or more, which is evaluated in conformity with JIS K5600-5-4.

13. A molded article of the polycarbonate-based resin composition of claim 1.
